(19) United States
(12) Patent Application Publication
(10) Pub. No.: US 2026/0288824 A1
(43) Pub. Date: Sep. 24, 2026

(54) SYSTEM

(71) Applicant: SoftBank Group Corp., Tokyo (JP)

(72) Inventor: Hiroyuki YAMAUCHI, Tokyo (JP)

(73) Assignee: SoftBank Group Corp., Tokyo (JP)

(21) Appl. No.: 19/568,950

(22) Filed: Mar. 17, 2026

(30) Foreign Application Priority Data
Mar. 19, 2025 (JP) 2025-045174

(51) Int. Cl. G06F 16/3329; G06Q 10/0631

(52) U.S. Cl. CPC G06F 16/33295; G06Q 10/06312

(57) ABSTRACT

A system includes a processor that is configured to observe, over a predetermined period, behavior data of employees and, in order to detect at an early stage problems including business delays, irregular attendance, minor mistakes, and lack of concentration based on the behavior data, use a prompt that instructs a generative AI model to analyze the behavior data, input a prompt that instructs the generative AI model to propose and implement appropriate remedial measures for problems detected by the generative AI model, and use a prompt that instructs the generative AI model to calculate an optimal allocation of resources, based on prediction results, in order to reduce loss of resources.

### CROSS-REFERENCE TO RELATED APPLICATION

This application is based on and claims priority under 35 USC 119 from Japanese Patent Application No. 2025-045174 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional employee management systems mainly focus on recording attendance, tracking working hours, and storing limited performance indicators. Such systems are not capable of comprehensively observing employee behavior data over a predetermined period and correlating that behavior with potential problems, such as business delays, irregular attendance, minor mistakes, and lack of concentration. As a result, companies often detect these problems only after they have already caused substantial damage, including productivity loss, increased error rates, and deterioration of workplace morale.

Furthermore, existing systems generally lack mechanisms to leverage generative AI models by means of prompts for analyzing complex and heterogeneous behavior data. They are not designed to instruct generative AI models to propose concrete remedial measures, nor to calculate optimal resource allocation based on prediction results. Consequently, even when some form of prediction is available, organizations have difficulty selecting and implementing timely and effective countermeasures, and they are unable to systematically reduce resource loss.

In addition, traditional solutions are insufficient for early detection and assessment of resignation risk. They rarely integrate behavior data and emotion data in a unified analytical framework, and they do not provide a structured way to instruct a generative AI model to evaluate resignation risk at an early stage. Therefore, there is a need for a system that can: (i) utilize prompts to instruct a generative AI model to analyze employee behavior data in order to detect various operational problems early, (ii) generate and support implementation of appropriate remedial measures, (iii) compute optimal resource allocation to minimize loss, and (iv) evaluate resignation risk based on combined behavior and emotion data to avoid worst-case situations.

### SUMMARY

In order to solve the above-described problems, an aspect of the present invention provides a system comprising a processor, wherein the processor is configured to observe, over a predetermined period, behavior data of employees and, in order to detect at an early stage problems including business delays, irregular attendance, minor mistakes, and lack of concentration based on the behavior data, use a prompt that instructs a generative AI model to analyze the behavior data. The processor is further configured to input a prompt that instructs the generative AI model to propose and implement appropriate remedial measures for problems detected by the generative AI model. In addition, the processor is configured to use a prompt that instructs the generative AI model to calculate an optimal allocation of resources, based on prediction results, in order to reduce loss of resources.

According to another aspect of the invention, the processor is configured to use a prompt that instructs the generative AI model to input past data into the generative AI model and to apply a prediction algorithm, in order to analyze behavior patterns by utilizing artificial intelligence and to perform prediction in consideration of past cases. By using such prompts, the system can generate prediction results that reflect historical correlations between behavior patterns and outcomes, thereby enabling more accurate detection of risks relating to business delays, attendance issues, minor mistakes, and lack of concentration.

According to still another aspect of the invention, the processor is configured to use a prompt that instructs the generative AI model to analyze employee behavior data and emotion data by using the generative AI model and to perform risk evaluation, in order to capture resignation risk at an early stage and avoid worst-case situations. By incorporating emotion data together with behavior data into the analysis, the system can provide a multi-dimensional assessment of resignation risk, enabling earlier and more precise identification of high-risk employees and supporting proactive intervention. Through these configurations, the system realizes an integrated platform that not only detects operational and human-resource-related problems early, but also guides remedial actions and resource allocation by effectively using generative AI models controlled by prompts.

The term “system” refers to an arrangement of one or more hardware devices, software components, and communication interfaces that cooperatively perform the functions described in the claims.

The term “processor” refers to one or more hardware processing units, such as a central processing unit (CPU), a microprocessor, a microcontroller, a digital signal processor, or a combination thereof, that executes instructions to perform the operations described in the claims.

The term “employee” refers to any individual who performs work or services for an organization, including full-time employees, part-time employees, contractors, temporary staff, and similar personnel.

The term “behavior data” refers to data representing actions, activities, or patterns of work-related conduct of employees over time, including, for example, work hours, attendance records, application usage logs, task execution logs, and interaction logs.

The term “emotion data” refers to data indicative of the emotional state or affective condition of employees, obtained from sources such as surveys, feedback forms, sentiment analysis of text, voice analysis, or other suitable measurements.

The term “over a predetermined period” refers to a time interval defined in advance by configuration or program logic, such as a day, a week, a month, or any other specified duration during which behavior data is collected or analyzed.

The term “generative AI model” refers to a machine learning model, such as a large language model or other generative model, that is capable of producing outputs including text, recommendations, or numerical values in response to input data and prompts.

The term “prompt” refers to data, typically in the form of text or structured instructions, that is supplied to a generative AI model to specify a task to be performed, such as analyzing input data, generating predictions, proposing remedial measures, or computing resource allocations.

The term “analyze the behavior data” refers to processing behavior data with a generative AI model or other algorithms to derive patterns, correlations, risk scores, classifications, predictions, or other interpretive results.

The term “problems” refers to undesired or adverse conditions in an organization's operations or human resources, including at least business delays, irregular attendance, minor mistakes, lack of concentration, and resignation risk.

The term “business delays” refers to delays or lateness in completion of assigned tasks, projects, or deliverables relative to scheduled deadlines or target dates.

The term “irregular attendance” refers to attendance patterns that deviate from expected or scheduled working times, including frequent lateness, early departure, unplanned absences, or inconsistent working hours.

The term “minor mistakes” refers to relatively small-scale errors, defects, or inaccuracies in work output, documentation, or processes that individually may have limited impact but may cumulatively affect quality or efficiency.

The term “lack of concentration” refers to a state or tendency in which an employee's sustained focus on work tasks is reduced, as inferred from behavioral indicators such as frequent context switching, prolonged idle time, or decreased productivity.

The term “remedial measures” refers to actions, interventions, or recommendations intended to reduce, mitigate, or eliminate detected problems, such as training, workload adjustment, counseling, schedule changes, task reassignment, or provision of support resources.

The term “implement appropriate remedial measures” refers to causing one or more remedial measures to be planned, initiated, or recorded for execution, for example by generating instructions, notifications, or task assignments based on proposals from a generative AI model.

The term “prediction results” refers to outputs generated by a generative AI model or associated prediction algorithms that estimate the likelihood, severity, or timing of problems, such as probabilities or risk scores for business delays, attendance issues, minor mistakes, lack of concentration, or resignation.

The term “resource allocation” refers to assignment or distribution of organizational resources, including human resources, time, budget, and tools, across tasks, projects, or employees.

The term “optimal allocation of resources” refers to a distribution of resources that satisfies at least one predetermined criterion, such as minimizing predicted loss or maximizing predicted productivity, as determined by a generative AI model or associated algorithms.

The term “loss of resources” refers to waste, underutilization, or inefficient use of organizational resources, including time, human effort, budget, and infrastructure, that results from or is associated with detected or predicted problems.

The term “prediction algorithm” refers to a computational procedure, implemented alone or together with a generative AI model, that uses past data and behavior patterns to estimate future outcomes or risks.

The term “past data” refers to previously collected and stored data, including historical behavior data, historical emotion data, and historical outcome data, that is used as input for analyzing patterns or training prediction algorithms.

The term “behavior patterns” refers to recurring or characteristic sequences, trends, or statistical properties of behavior data associated with one or more employees over time.

The term “resignation risk” refers to the likelihood that an employee will voluntarily leave the organization within a certain time frame, as assessed based on behavior data, emotion data, or other indicators.

The term “risk evaluation” refers to the process of estimating, scoring, or categorizing the magnitude or likelihood of specific risks, such as resignation risk or operational problems, based on analysis performed by a generative AI model or related algorithms.

The term “early stage” refers to a time point before a problem or risk has fully materialized or caused substantial adverse impact, such that remedial measures or interventions can still significantly reduce or avoid the impact.

The term “worst-case situations” refers to highly adverse outcomes that the organization seeks to avoid, including, for example, sudden resignations of key employees, severe productivity loss, or major operational disruptions.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

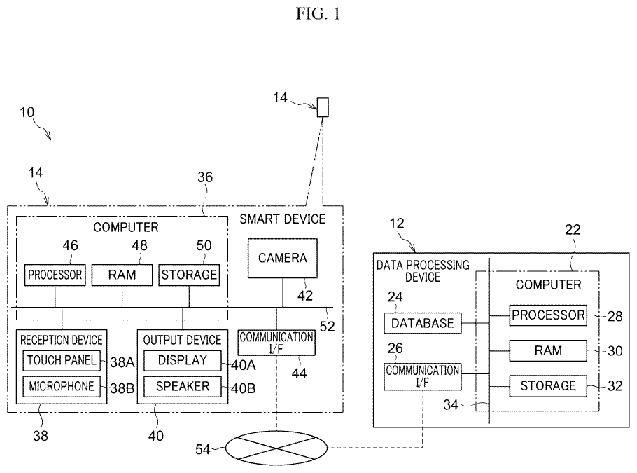

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

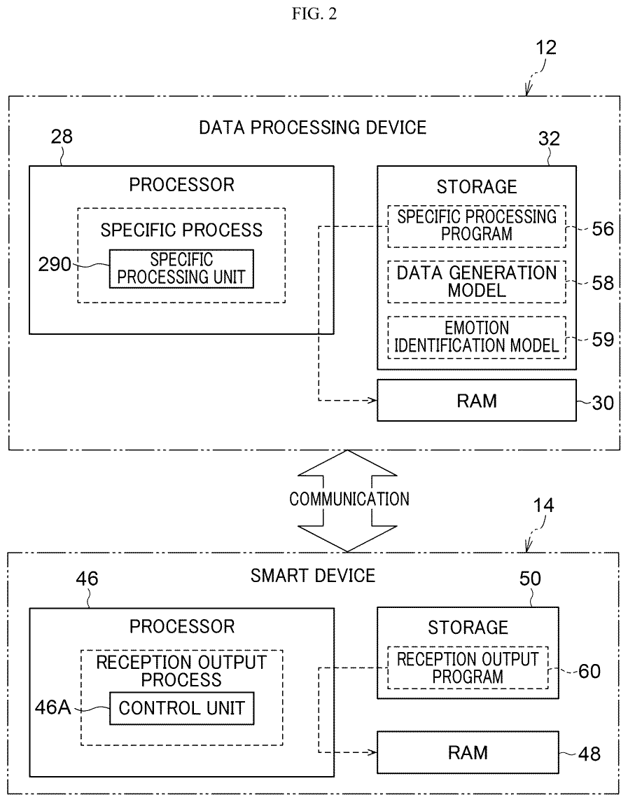

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional employee behavior monitoring systems mainly collect log data from information processing devices and provide simple statistical dashboards such as average working hours or application usage counts. These systems are typically implemented as fixed pipelines that aggregate logs, compute basic metrics, and render static charts. As a result, such systems suffer from several technical limitations.

First, existing systems lack an integrated mechanism for transforming heterogeneous, time-series usage data into structured behavioral feature representations that can be reliably processed at scale. Raw usage logs from multiple devices, time zones, and application categories are often noisy, incomplete, and inconsistent, which leads to low-quality feature extraction and unstable downstream analytics. The absence of a standardized behavioral feature matrix impedes accurate behavior pattern analysis and makes it difficult to reuse data across different analytic functions.

Second, existing systems rely on predetermined rules or static machine learning models that are not easily adaptable to new patterns or organizational contexts. These systems generally do not support a dynamic interaction between automated behavioral clustering and higher-level reasoning engines. In particular, they do not provide a mechanism by which a computing system can automatically generate prompt sentences and control information that drive a generative artificial intelligence model to perform advanced reasoning, explanation, and planning over the analytical results. Consequently, the system cannot flexibly adjust to newly emerging behavior patterns, changing work styles, or new types of risks, and tends to degrade in performance over time.

Third, in conventional architectures, advanced narrative analysis and decision support are often offloaded to human experts who manually interpret dashboards and compose recommendations. This creates latency, introduces subjectivity, and limits scalability. There is no technical framework in which the same computational substrate that collects and clusters behavior can also orchestrate generative artificial intelligence to automatically generate tailored remedial measures, improvement plans, and resource allocation schemes based on the current behavioral state of the organization. The lack of tight integration between low-level data processing and high-level generative reasoning prevents the system from providing timely, context-aware interventions.

Fourth, traditional systems do not provide a unified prompt-control mechanism that encodes, at the system level, how different categories of internal analytic artifacts—such as behavioral pattern information, usage-state data, historical patterns, and emotion-related data—are to be composed into machine-interpretable prompt sentences for a generative artificial intelligence model. Without such a mechanism, prompts tend to be ad hoc and manually crafted, which leads to inconsistent outputs, difficulty in versioning and auditing, and suboptimal use of the generative model's capabilities. This also makes it difficult to implement automated workflows such as early detection of attendance irregularities, prediction of resource demand, and evaluation of separation risk.

Accordingly, there is a need for a technical solution that improves computer technology by: (i) providing a robust data processing pipeline that converts heterogeneous usage logs into a structured behavioral feature matrix; (ii) applying scalable machine learning clustering to derive stable behavioral pattern groups and associated pattern information; and (iii) integrating, at the system level, a prompt generation and control mechanism that programmatically drives a generative artificial intelligence model using internal analytic results. Such a solution should enable a computing system to automatically detect potential problems such as business delays, irregular attendance, minor operational errors, lack of concentration, and inefficient resource allocation, and to generate and execute context-aware response measures with reduced human intervention and improved computational efficiency.

The specific processing by the specific processing unit 290 of the data processing device 12 in Example 1 is realized by the following means.

The present invention provides a server comprising a processor configured to collect, via an agent operating on an information processing device and via a communication interface, usage-state data including at least a use history of the information processing device, start and end times of operation, types of processing executed on the information processing device and use times thereof, and access history to an information communication network, for each of a plurality of subjects over a predetermined period, and to aggregate the usage-state data via a communication network; to format the aggregated usage-state data by executing, in memory, preprocessing including completion of missing values, removal of abnormal values, and normalization of time information, and to calculate, for each subject and for each predetermined unit period, at least one behavioral feature quantity including at least a start time, an end time, an operation time of the information processing device in the unit period, a use time per processing category on the information processing device, and a use ratio in a predetermined time band, thereby constructing a behavioral feature matrix stored in a data storage; to apply, to the behavioral feature matrix, a numerical scaling process and a machine learning process including a clustering process so as to classify the subjects into a plurality of behavioral pattern groups, and to calculate, for each behavioral pattern group, statistics indicating tendencies of the start times, the end times, the operation times, and the use in a specific time band, thereby generating behavioral pattern information representing characteristics of each behavioral pattern group; to convert analysis results including the behavioral pattern information and belonging-behavioral-pattern-group information for each subject into report information for visual display, and to provide the report information, via the communication interface, in response to a viewing request received from a management terminal; to generate, in order to detect at an early stage at least one of a business delay, an irregularity in attendance, a minor operational error, a lack of concentration, and an inefficiency in resource allocation, a prompt sentence including analysis-target information based on at least the behavioral pattern information and the usage-state data, and to generate prompt control information that instructs input of the prompt sentence to a generative artificial intelligence model and execution of an analysis process by the generative artificial intelligence model; and to acquire, on the basis of analysis results output from the generative artificial intelligence model, response-measure information including at least one of a remedial measure, an improvement measure, and a resource allocation plan, and to associate the response-measure information with the report information for presentation and/or to generate control information for automatically executing at least a part of the response-measure information. This enables the computing system to transform heterogeneous device usage logs into a structured behavioral feature representation, to automatically derive stable behavioral pattern groups through machine learning, and to programmatically orchestrate a generative artificial intelligence model via system-generated prompt sentences and prompt control information, thereby improving the technical performance and adaptability of behavior analysis, early problem detection, and resource allocation in an automated and scalable manner.

The term “system” refers to an integrated combination of at least one hardware device and at least one software component that cooperatively perform the processing described in the claims.

The term “processor” refers to a hardware computation unit, such as a central processing unit or a processing core, that executes instructions to perform data collection, data preprocessing, machine learning, prompt generation, and control of a generative artificial intelligence model.

The term “information processing device” refers to an electronic apparatus capable of executing programs, processing data, and communicating over a network, including but not limited to a personal computer, a portable terminal, or a communication-enabled computing device.

The term “agent” refers to a software component that runs on an information processing device and is configured to monitor device operation, acquire usage-state data, and transmit the usage-state data to a server or another processing node.

The term “usage-state data” refers to data indicating how an information processing device is operated, including at least a use history, start and end times of operation, types of processing executed, use times of the processing, and access history to an information communication network.

The term “use history” refers to a chronological record of operations performed on an information processing device, including application launches, foreground-window changes, and user interaction events.

The term “start and end times of operation” refers to times indicating when a subject begins using and stops using an information processing device within a predetermined unit period, such as a working day.

The term “types of processing executed” refers to categories or kinds of operations carried out on an information processing device, such as document editing, communication, data entry, or web browsing.

The term “use times” refers to durations during which particular types of processing or applications are active or in use on an information processing device.

The term “access history to an information communication network” refers to records of connections from an information processing device to a communication network, including at least connection times, destination identifiers, and durations of access.

The term “subject” refers to an entity whose behavior is to be analyzed, typically a user or operator associated with one or more information processing devices and corresponding usage-state data.

The term “communication network” refers to a wired or wireless data communication infrastructure, including at least the Internet, local area networks, or wide area networks, through which data is transmitted between devices.

The term “aggregate” refers to a process of collecting, consolidating, and storing usage-state data from multiple information processing devices and multiple subjects into a unified data storage for subsequent processing.

The term “preprocessing” refers to operations performed on raw usage-state data prior to analysis, including at least completion of missing values, removal of abnormal values, and normalization of time information.

The term “completion of missing values” refers to a process of estimating and filling in absent or undefined data points within usage-state data using predefined rules or statistical methods.

The term “removal of abnormal values” refers to a process of identifying and excluding or adjusting data points that deviate from expected ranges or patterns and are likely to represent noise, errors, or outliers.

The term “normalization of time information” refers to a process of transforming time-related data, such as timestamps, into a standardized representation suitable for comparison and machine learning, including conversion of time zones and mapping to relative or normalized scales.

The term “behavioral feature quantity” refers to a numerical or categorical value derived from usage-state data that characterizes an aspect of a subject's behavior, such as a start time, an end time, an operation time, a use time per category, or a use ratio in a predetermined time band.

The term “behavioral feature matrix” refers to a structured data representation in which each row corresponds to a subject or a subject-period combination and each column corresponds to a behavioral feature quantity.

The term “predetermined unit period” refers to a time interval used as a basis for aggregating and analyzing behavior, such as a day, a week, or a work shift, which is set in advance by system configuration.

The term “operation time” refers to a duration within a predetermined unit period during which an information processing device is in active use by a subject.

The term “use time per processing category” refers to a duration within a predetermined unit period during which processing belonging to a particular category, such as communication or content creation, is executed on an information processing device.

The term “use ratio in a predetermined time band” refers to a proportion of operation time or use time that occurs within a specified time range, such as early morning hours, regular working hours, or nighttime hours.

The term “numerical scaling process” refers to a computational operation that transforms numerical behavioral feature quantities into a normalized or standardized range, such as zero mean and unit variance, to facilitate machine learning.

The term “machine learning process” refers to a computational procedure that automatically infers patterns or structures from data, including but not limited to clustering, classification, or regression.

The term “clustering process” refers to a type of machine learning process that partitions subjects into groups such that subjects within the same group exhibit similar behavioral feature quantities.

The term “behavioral pattern group” refers to a cluster or group of subjects that share similar behavior characteristics as determined by the clustering process applied to the behavioral feature matrix.

The term “behavioral pattern information” refers to data describing characteristics of a behavioral pattern group, including at least statistics of start times, end times, operation times, and use in specific time bands.

The term “statistics” refers to numerical descriptors derived from data, such as averages, medians, variances, or distribution indicators, that summarize tendencies within a behavioral pattern group.

The term “analysis results” refers to outputs produced by the data processing and machine learning processes, including at least behavioral pattern information and information indicating to which behavioral pattern group each subject belongs.

The term “belonging-behavioral-pattern-group information” refers to data that associates each subject with one of the behavioral pattern groups determined by the clustering process.

The term “report information” refers to structured data prepared for visual presentation, including at least tables, charts, and textual summaries derived from the analysis results.

The term “management terminal” refers to an information processing device operated by a managing user or administrator to request, receive, and display report information.

The term “viewing request” refers to a request signal transmitted from a management terminal to the system to obtain and display specified report information.

The term “business delay” refers to a condition in which tasks or processes are not completed within expected time frames, as inferred from behavioral feature quantities and usage-state data.

The term “irregularity in attendance” refers to a deviation from expected attendance patterns, including unusual start times, end times, or presence durations, as detected from usage-state data.

The term “minor operational error” refers to a small-scale mistake or anomaly in device operation or application usage that may indicate reduced accuracy or attention, as inferred from patterns in usage-state data.

The term “lack of concentration” refers to a behavioral tendency characterized by fragmented or inconsistent device usage, frequent context switching, or irregular patterns that suggest reduced sustained focus.

The term “inefficiency in resource allocation” refers to a state in which computing, human, or time resources are not distributed in a manner aligned with workload or behavioral patterns, as inferred from system analysis.

The term “prompt sentence” refers to a machine-readable textual instruction or query constructed by the system to be input to a generative artificial intelligence model in order to request analysis, prediction, or generation of response measures.

The term “analysis-target information” refers to data selected by the system as input context for a generative artificial intelligence model, including at least behavioral pattern information and usage-state data.

The term “prompt control information” refers to control data generated by the processor that specifies how and when a prompt sentence is to be provided to a generative artificial intelligence model and what type of analysis the model is to perform.

The term “generative artificial intelligence model” refers to a machine-learned model configured to generate output data, such as text, in response to an input prompt sentence, based on patterns learned from training data.

The term “analysis process by the generative artificial intelligence model” refers to a computational operation in which the generative artificial intelligence model receives a prompt sentence and generates output describing analysis results, explanations, predictions, or recommended measures.

The term “analysis results output from the generative artificial intelligence model” refers to data produced by the generative artificial intelligence model in response to a prompt sentence, including at least evaluations, recommendations, or narrative explanations.

The term “response-measure information” refers to information representing actions or plans to address detected issues, including at least remedial measures, improvement measures, and resource allocation plans.

The term “remedial measure” refers to an action proposed to correct or mitigate a detected problem, such as a business delay or attendance irregularity.

The term “improvement measure” refers to an action proposed to enhance behavior or processes, such as optimizing work schedules or reducing disruptive usage patterns.

The term “resource allocation plan” refers to a plan for distributing computational, temporal, or human resources across tasks or subjects based on analysis of behavioral patterns and predicted resource needs.

The term “control information” refers to machine-interpretable data that instructs other system components or external systems to execute specific operations, including automatic execution of at least a part of the response-measure information.

The term “history information” refers to accumulated past data regarding usage-state data and behavioral pattern information, which is used as input to prediction or trend analysis by the generative artificial intelligence model.

The term “future behavioral pattern” refers to a predicted pattern of behavior of a subject or group of subjects in a forthcoming period, generated based on history information.

The term “probability of problem occurrence” refers to a likelihood value indicating the chance that a particular type of problem, such as a delay or irregularity, will arise in the future.

The term “future resource demand” refers to a predicted requirement for resources, such as processing time, staffing, or device capacity, inferred from past and current behavioral patterns.

The term “evaluation-target information” refers to data provided to the generative artificial intelligence model for risk assessment, including behavioral feature quantities and emotion-related data.

The term “emotion-related data” refers to data indicative of an emotional state of a subject, such as sentiment indicators, stress markers, or mood estimations derived from system interactions or other measurements.

The term “risk evaluation” refers to an assessment of the likelihood and potential impact of undesirable events, such as resignation or other separation of a subject, based on evaluation-target information.

The term “resignation risk” refers to a likelihood that a subject will voluntarily leave an organization, as evaluated from behavioral and emotion-related data.

The term “separation risk” refers to a likelihood that a subject will cease to be associated with an organization, including resignation or other forms of departure.

The term “measure proposals for reducing the risk” refers to recommended actions or strategies generated by the generative artificial intelligence model to lower assessed risks, such as resignation risk or separation risk.

In one embodiment, a server generates and executes a program configured to observe behavior patterns of multiple subjects through their use of terminals, to perform feature extraction and clustering using machine learning, and to control a generative AI model using systematically constructed prompt sentences. The server comprises at least one processor, a main memory, a non-volatile storage device, and a network interface. The terminals each comprise a processor, a memory, a storage device, an operating system, and a network interface, and execute an agent program generated and distributed by the server.

The server uses the processor to generate an agent program adapted to the operating system of each terminal. For example, the server generates an agent as a background service on a personal computer operating system, and as an application or service on a smartphone operating system. The agent is configured to use system APIs, such as process enumeration APIs, event logging APIs, and network connection monitoring APIs, to acquire usage-state data including: login and logout times, foreground application identifiers, window focus changes, process categories, and access destinations on a communication network. The agent periodically stores the acquired usage-state data in a local buffer in the memory of the terminal and transmits the buffered data to the server through the network interface using encrypted communication.

The terminal operates the agent such that the agent runs automatically when the operating system starts and continues to monitor device activity. The terminal uses timestamps generated by the operating system clock to tag each event, and the agent attaches identifiers of the terminal and of the subject (for example, an anonymized subject identifier) to each record. The terminal converts raw events into a simple structured log format including fields such as event type, timestamp, application category, and data volume. The agent accumulates these logs in the local storage device when the terminal is temporarily offline and transmits them in batches when a network connection becomes available. This batching reduces connection establishment overhead and decreases communication load compared with transmitting each event individually.

The server uses the network interface to receive the usage-state data transmitted from a plurality of terminals. The server writes the received data into a raw log storage implemented on a database management system or a file-based columnar storage. The server assigns an internal sequence identifier and a reception time to each record and maintains indexing structures optimized for queries by subject identifier and by time period. By using an index structure, the server reduces the time required to retrieve logs for a particular subject and period, and thereby improves data access performance for subsequent analysis.

The server uses a data-processing module executed by the processor to convert the raw usage-state data into a behavioral feature matrix. In one example, the server implements this module using a programming language runtime and a numerical computation library such as a table-oriented data processing library. The server loads raw logs for a given analysis period into main memory as a table structure, where each row corresponds to a single event and each column corresponds to an attribute such as timestamp, subject identifier, terminal identifier, application category, and event duration.

The server performs missing-value completion by detecting gaps in data, such as a missing logout time when only a login time and subsequent activity records are present. The server estimates a probable logout time using a rule that selects the last activity time preceding a long inactivity interval that exceeds a threshold. By performing this rule-based estimation automatically, the server reduces the number of records that would otherwise be discarded and thus improves the completeness of the behavioral feature matrix.

The server performs removal of abnormal values by comparing each record against configurable constraints. For example, the server removes or flags a login time earlier than a specified earliest allowable hour, or an operation time exceeding a specified maximum daily time. The server may store these thresholds in configuration tables that can be adjusted by a user through an administrative interface. By filtering out abnormal values before feature calculation, the server reduces noise in the data and improves the stability and accuracy of clustering.

The server normalizes time information by converting timestamps into a standardized time zone and then computing relative features such as hour-of-day values and day-of-week indicators. The server aggregates events by subject and by unit period (for example, by day) and calculates behavioral feature quantities such as: average start time in the unit period; average end time; total operation time; total use time for each processing category (for example, communication, document editing, browsing); and a use ratio within specified time bands such as regular hours and nighttime hours. The server stores these behavioral feature quantities in a matrix where each row corresponds to a subject and each column corresponds to a feature. Because the server uses a fixed column schema and standard numeric formats, the behavioral feature matrix is directly usable by machine learning libraries without further transformation, which reduces computational overhead.

The server uses a machine learning module to process the behavioral feature matrix. In one embodiment, the server uses a numerical array library and a machine learning library to apply scaling and clustering. The server uses a standardization function to transform each numerical feature to have approximately zero mean and unit variance across the set of subjects. This scaling prevents features with large numeric ranges from dominating the clustering distance computation, thereby improving the balance and quality of clustering.

The server uses a clustering algorithm based on an iterative centroid-update method, such as a K-means algorithm, to partition the subjects into behavioral pattern groups. The server initializes cluster centroids using a seeding method that spreads initial centers across the data distribution, and iteratively assigns each subject to the nearest centroid according to Euclidean distance in the scaled feature space. The server repeats centroid updates and assignments until a convergence condition, such as a small change in centroids or a maximum number of iterations, is satisfied. By running this algorithm on the behavioral feature matrix, the server automatically derives groups of subjects with similar behavioral characteristics, which would be difficult to define by static rules.

The server calculates behavioral pattern information by aggregating the behavioral feature matrix for each cluster. The server computes statistics such as mean and standard deviation of start time, end time, daily operation time, and nighttime use ratio within each cluster. The server may also compute quantiles and frequency distributions for selected features. The server stores these statistics together with a cluster identifier in a pattern information storage. Because the pattern information is pre-computed and stored, the server can respond quickly to user requests for summaries without recalculating statistics from raw data.

The server converts the analysis results, including the behavioral pattern information and the association between each subject and a behavioral pattern group, into report information suitable for visual display. In one embodiment, the server uses a template engine to generate hypertext documents that include tables of clusters, lists of members, and graphical elements such as bar charts and line graphs. The server uses a chart rendering library to pre-render images having compressed formats so that they can be transmitted efficiently to terminals. By generating static or semi-static visual content at the server side, the system reduces processing load on the terminals and decreases the amount of client-side scripting required.

The user operates a management terminal to access a web-based interface exposed by the server. The user authenticates to the server and then queries for behavior analysis reports for a particular department or period. In response, the server retrieves pre-generated report information from storage and transmits it to the terminal. The terminal renders the report information using a web browser, presenting cluster descriptions, behavior statistics, and subject lists. The user can interact with the report, for example by selecting a cluster to view detailed statistics or by selecting a particular subject to view daily time-series charts.

The server further uses the processor to control a generative AI model through prompt sentences constructed from internal analytic artifacts. In one embodiment, the server accesses a generative AI model implemented as a neural network having a transformer architecture with multiple layers of self-attention and feed-forward sublayers. The model parameters are stored on a remote inference service or on a specialized accelerator device. The server prepares an input sequence of tokens, where each token represents a word or subword unit.

The server constructs a prompt sentence by combining textual descriptions of behavioral pattern information, summary statistics, and contextual instructions. For example, the server generates the following prompt sentence for cluster summarization:
“Summarize the following employee behavior clusters for a management report.
Cluster 0: 60 subjects, average start time 09:05, average end time 18:02, low overtime and low night-time usage.
Cluster 1: 8 subjects, average start time 08:10, average end time 21:15, frequent evening work and high overtime.
Cluster 2: 5 subjects, large day-to-day variability of start time, some logins after 23:00, high night-time usage.
Explain possible operational risks and concrete suggestions in approximately 300 words.”

The server also constructs prompt sentences for prediction and resource allocation, such as:
“Using the past three months of behavioral feature data, predict which behavior clusters are likely to grow in size next month and which subjects are at high risk of irregular attendance. Provide a list of features that contribute most to the prediction.”

The server converts the prompt sentence into tokens using a tokenizer compatible with the generative AI model, and sends the tokenized sequence to the inference endpoint. Internally, the generative AI model performs a series of matrix multiplications and non-linear transformations to compute attention weights over the input tokens and to generate output token probabilities at each position. The model uses learned attention patterns to focus on specific numerical descriptions (for example, high overtime values or night-time usage ratios) when generating recommendations.

The server receives the output tokens from the generative AI model and decodes them into text. The server parses the generated text to extract structured response-measure information, such as lists of recommended actions and associated rationales. The server may apply pattern-matching rules or simple classifiers to detect specific keywords indicating types of measures, such as “adjust shift timing,” “limit night-time access,” or “introduce break reminders.” By automatically extracting structured recommendations from the generated text, the server reduces manual post-processing and allows the system to generate machine-readable control information.

The server associates the response-measure information with the existing report information. For example, the server adds a section titled “Recommended Measures” to each cluster summary, and populates it with bullet-point actions generated by the generative AI model. The server may also generate control information for automatic execution of certain measures, such as adjusting notification schedules on terminals or modifying threshold values used for abnormal-value detection. The server stores these control parameters in configuration repositories and distributes updated settings to agents on terminals via the network. In this way, the system is not limited to passive reporting but also actively modifies operational parameters of devices based on learned patterns, achieving a closed feedback loop.

The server uses specific data structures and processing flows to achieve technical improvements. By structuring data as a behavioral feature matrix and by precomputing cluster-level statistics, the server reduces the dimensionality and redundancy of raw logs, thereby decreasing memory usage and improving cache efficiency in the processor. The use of feature scaling before clustering improves numerical stability of distance computations in floating-point arithmetic, which reduces the risk of convergence failures or degenerate clusters. The combination of rule-based preprocessing and clustering yields more stable clusters than static rule-based grouping alone, which improves the precision and recall of early detection of problematic behavior patterns.

The integration of generative AI is implemented in a manner that enhances computer operation beyond simple replacement of human analysts. The server systematically constructs prompt sentences from internal structured data according to predefined templates and rules. This reduces variability in prompts and allows caching and reuse of model outputs for similar feature configurations, which in turn reduces computation load on the generative AI infrastructure. The server may also maintain a mapping between feature patterns and generated measure sets, so that common patterns can be served from a local recommendation cache rather than invoking the generative model each time. This reduces network latency and inference cost, and thus improves the overall performance of the system.

The server can employ alternative neural network architectures for the generative AI model, such as encoder-decoder transformers, recurrent neural networks with attention, or hybrid models, as long as they can receive prompt sentences and generate textual outputs. In each case, the server controls hyperparameters such as maximum sequence length, decoding strategy (for example, greedy decoding, beam search, or nucleus sampling), and temperature, to balance determinism and diversity of generated recommendations. The server may adjust these parameters depending on the use case: for example, using lower temperature and beam search for safety-critical recommendations, and higher temperature for exploratory improvement ideas.

The system architecture allows several variations. In a first variation, the server and the generative AI model operate on the same physical machine, and the model uses a local graphics processing unit to accelerate matrix computations. In a second variation, the generative AI model is accessed through a remote inference service over a wide-area network, and the server includes a throttling mechanism to control the rate of requests according to available bandwidth. In a third variation, multiple servers cooperate, each processing a subset of subjects, and a coordinator server collects cluster summaries and generates organization-wide prompt sentences.

The terminals can also vary. One terminal may be a desktop computer connected to a wired network, whereas another terminal may be a mobile device connected via a wireless network. The agent implementation can be adapted to each platform but uses the same logical event schema, allowing the server to aggregate and analyze cross-device behavior of a single subject.

The described configuration yields technical effects beyond mere automation of human analysis. Because the server automatically aligns heterogeneous event logs into a unified feature space and continuously retrains clustering on updated data, the system can rapidly detect shifts in collective behavior, such as an increase in late-night usage, without reprogramming static rules. The behavioral feature matrix, combined with scalable clustering and standardized prompt control, improves both the precision and speed of behavior analysis by reducing manual data preparation and ad hoc interpretation. Furthermore, by enabling the server to derive machine-readable response measures and to modify configuration of agents and thresholds based on these measures, the system closes a feedback loop that proactively optimizes resource usage and reduces abnormal patterns. This end-to-end, data-driven control flow improves the efficiency of computation, the quality of behavioral modeling, and the robustness of device management compared with conventional systems that only present static dashboards without integrated generative reasoning and control.

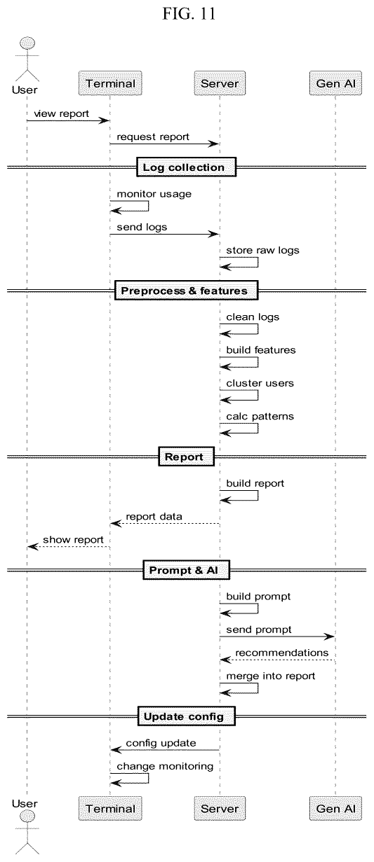

The following describes the processing flow using FIG. 11.

### Step 1:

The terminal starts an agent process when the operating system boots and initializes monitoring.
The input is the operating system environment, including process APIs, event logs, and network interfaces.
The terminal uses these resources to detect user login, user logout, foreground window changes, application launches and exits, and network connections.
The terminal creates a structured log record for each event, including at least a timestamp, a terminal identifier, a subject identifier, an event type, an application category, and an event duration when applicable.
The output of Step 1 is a sequence of raw event logs stored in a local buffer or file on the terminal.

### Step 2:

The terminal periodically packages the locally buffered raw event logs and transmits them to the server.
The input is the set of raw event logs accumulated since the previous transmission, together with authentication credentials and configuration parameters indicating a transmission interval and a maximum batch size.
The terminal groups the logs into batches, serializes them into a structured message format, and encrypts the message using a transport security protocol.
The terminal sends the encrypted message over a communication network to a designated server endpoint and, upon successful acknowledgment, clears the transmitted logs from the local buffer.
The output of Step 2 is a set of encrypted usage-state data packets delivered to the server.

### Step 3:

The server receives the usage-state data packets from a plurality of terminals and stores them as raw usage-state data.
The input is the encrypted packets arriving at a network interface of the server.
The server decrypts each packet, verifies authentication tokens and integrity checksums, parses the structured message, and extracts individual event records.
The server assigns an internal sequence identifier and a reception timestamp to each record and writes the records into a raw log storage, such as a database table or columnar file, indexed by subject identifier and time.
The output of Step 3 is a persistent raw usage-state dataset stored on the server, organized for efficient retrieval by subject and period.

### Step 4:

The server loads a subset of the raw usage-state dataset for a target analysis period and performs preprocessing.
The input is a query definition specifying a time range and a group of subjects or departments, and the corresponding raw usage-state records retrieved from storage.
The server loads these records into a tabular in-memory structure, detects missing values such as absent logout times or missing application durations, and identifies abnormal values such as login times outside allowable ranges or excessive daily operation times.
The server applies rule-based completion to estimate missing values, for example by substituting the last observed activity time as a logout time, and filters or flags abnormal records according to configurable thresholds.
The output of Step 4 is a cleaned event table in memory, in which missing values are filled and abnormal values are removed or marked.

### Step 5:

The server aggregates the cleaned event table by subject and unit period to construct a behavioral feature matrix.
The input is the cleaned event table containing per-event records with subject identifiers, timestamps, application categories, and durations.
The server groups events by subject and by unit period, such as by day, and calculates for each group features including first login time, last logout time, total operation time, total duration per application category, and ratios of operation within specified time bands such as regular working hours and nighttime.
The server then aggregates these per-period features across the analysis horizon, computing per-subject averages, variances, and ratios, and stores them in a matrix representation where rows correspond to subjects and columns correspond to behavioral feature quantities.
The output of Step 5 is a behavioral feature matrix ready for numerical processing by machine learning algorithms.

### Step 6:

The server scales the behavioral feature matrix and applies clustering to derive behavioral pattern groups.
The input is the behavioral feature matrix containing numerical feature columns for all subjects.
The server computes, for each feature column, a mean and standard deviation, and transforms each feature value into a standardized value by subtracting the mean and dividing by the standard deviation.
The server initializes cluster centroids in the standardized feature space and iteratively assigns each subject to the nearest centroid based on Euclidean distance, then updates the centroids as the mean of assigned subjects, repeating until convergence criteria are satisfied.
The output of Step 6 is a set of cluster labels assigned to each subject and a set of final cluster centroids and associated distance metrics.

### Step 7:

The server computes behavioral pattern information for each cluster and stores it for later reporting.
The input is the standardized behavioral feature matrix, the cluster labels for each subject, and cluster centroids.
The server groups subjects by cluster label and calculates cluster-level statistics such as mean and variance of start time, end time, daily operation time, nighttime usage ratio, and category-specific usage durations.
The server generates a behavioral pattern descriptor for each cluster, including numerical summaries and text labels such as “standard schedule,” “long-hours pattern,” or “irregular night-use pattern,” based on thresholds and rule sets.
The output of Step 7 is a behavioral pattern information dataset that associates each cluster identifier with descriptive statistics and semantic labels.

### Step 8:

The server generates report information for visual display to a user operating a management terminal.
The input is the behavioral pattern information, the cluster labels per subject, and optional filtering criteria such as department, time range, or subject group.
The server constructs summary tables listing clusters, subject counts, and key statistics; constructs detailed tables mapping subjects to their assigned clusters; and generates visual elements such as bar charts or line graphs using a chart rendering library.
The server embeds these elements in a report template, producing hypertext or document content that can be transmitted and rendered by a browser on the terminal.
The output of Step 8 is structured report information stored on the server and prepared for distribution to requesting terminals.

### Step 9:

The user accesses the report using a management terminal and interacts with the displayed information.
The input is a report selection command and viewing request generated by the user through a web browser interface.
The terminal sends the viewing request to the server, receives the corresponding report information, and renders it on a display device, including cluster summaries, subject lists, and charts.
The user inspects the behavioral patterns, identifies clusters of interest, and may select individual clusters or subjects to drill down into more detailed views.
The output of Step 9 is user interaction context, including selected clusters, subjects, and report sections, which can be forwarded back to the server as additional requests.

### Step 10:

The server constructs a prompt sentence using internal analytic results and prepares a request for a generative AI model.
The input is the behavioral pattern information, cluster statistics, and, optionally, history information such as past cluster distributions and feature trends.
The server selects relevant statistics and converts them into natural language fragments, then concatenates them with an instruction template to form a complete prompt sentence.
For example, the server may generate the following prompt sentence:
“Summarize the following behavior clusters for a management report.
Cluster 0: 60 subjects, average start time 09:05, average end time 18:02, low overtime and low night-time usage.
Cluster 1: 8 subjects, average start time 08:10, average end time 21:15, frequent evening work and high overtime.
Cluster 2: 5 subjects, large day-to-day variability of start time, some logins after 23:00, high night-time usage.
Explain possible risks and concrete operational suggestions in about 300 words.”
The server tokenizes the prompt sentence using a tokenizer corresponding to the generative AI model and prepares a request payload.
The output of Step 10 is a model-ready prompt sequence and a request object for the generative AI model.

### Step 11:

The server sends the prompt request to the generative AI model and obtains generated narrative recommendations.
The input is the tokenized prompt sequence and model configuration parameters such as maximum output length, decoding strategy, and temperature.
The server transmits the request to a model inference endpoint, where the generative AI model processes the tokens through its layers, computing attention scores and generating output token probabilities at each position according to its learned parameters.
The server receives the output tokens, decodes them into text, and parses the text to identify recommendations, risk assessments, and suggested measures, optionally using pattern-matching rules and simple classifiers to structure the output.
The output of Step 11 is a narrative recommendation text and structured response-measure information derived from the generative AI model output.

### Step 12:

The server integrates the response-measure information into the report and, optionally, generates control information for automated actions.
The input is the existing report information and the structured response-measure information including remedial measures, improvement measures, and resource allocation plans.
The server inserts new sections into the report, such as “AI-Generated Recommendations,” and attaches each measure to the corresponding cluster or subject context.
The server also maps certain measures to system actions, such as modifying abnormal-value thresholds, changing notification schedules, or enabling additional monitoring, and encodes these as configuration updates or control commands to be distributed to agents on terminals.
The output of Step 12 is an augmented report containing recommendations and a set of control information records that can be applied to adjust system behavior.

### Step 13:

The terminal receives updated configuration or control information from the server and modifies its monitoring behavior accordingly.
The input is a configuration update message transmitted by the server that may include revised thresholds for inactivity detection, new categories of applications to monitor more closely, or modified data transmission intervals.
The terminal validates the update, writes the new parameters to local configuration storage, and adjusts the agent's runtime behavior, for example by changing the inactivity timeout used to infer logout events or by increasing the sampling frequency for certain event types.
The terminal then continues monitoring and logging under the new configuration, feeding improved data back into the server's analysis pipeline.
The output of Step 13 is updated local monitoring behavior on the terminal, which results in refined usage-state data for subsequent analysis cycles.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional workforce and equipment management systems typically process human behavior data and machine operation data in separate subsystems. Human behavior monitoring tools often focus only on time and attendance or simple activity logs, while equipment maintenance systems rely mainly on periodic schedules or threshold-based alerts from individual sensors. As a result, these systems suffer from several technical problems.

First, the underlying data processing pipelines are fragmented. Human-related data, such as device usage logs or working hours, and machine-related data, such as sensor readings and maintenance records, are stored in different data structures and analyzed independently. This fragmentation prevents the computing system from efficiently detecting cross-domain patterns, such as correlations between employee fatigue and abnormal machine operation. The lack of unified data representation leads to duplicated processing logic, inconsistent time normalization, and increased latency when generating decision-support information.

Second, existing systems largely apply rigid rule-based logic or fixed machine learning models that require predefined input features. These approaches are not well suited for dynamically evolving environments where behavior patterns, production conditions, and failure modes frequently change. When new data types or event patterns arise, significant manual reconfiguration of feature engineering and rule sets is required. This results in poor scalability and limits the ability of the computing system to adapt to new use cases without extensive redevelopment.

Third, known architectures provide limited support for dynamically composing context-rich inputs for advanced artificial intelligence models. In many implementations, AI components are invoked with simplistic or static parameter sets, and historical information, cross-entity relationships, and prior outcomes are not systematically integrated into the AI input. Consequently, the AI output often lacks precision and relevance, and the system cannot fully exploit powerful generative AI models for predictive analytics and prescriptive recommendations.

Fourth, user-facing visualization layers are typically loosely coupled to the analytics core. Dashboards are updated based on periodic batch jobs that do not capture the latest AI-derived insights in real time. Feedback from user decisions, such as adjustments to work schedules or rescheduled maintenance actions, is rarely fed back into the analytical data model. This breaks the feedback loop required to continuously refine risk evaluations and recommendations, and it degrades the effectiveness of the data processing pipeline over time.

Accordingly, there is a need for an improved computer-implemented technique that: (i) unifies heterogeneous human behavior information, machine operation information, attribute information, and maintenance history information into integrated management information in a consistent data representation; (ii) automatically detects high-risk conditions in both human and machine domains using this integrated representation; (iii) programmatically generates prompt sentences that encode rich temporal patterns and context as input to a generative AI model; (iv) orchestrates bidirectional interaction with the generative AI model to obtain prediction information and recommendation information; and (v) converts the AI output into optimized planning information that is visualized and iteratively refined based on user feedback. Such a technique would improve the functioning of the underlying computer system itself by enhancing data integration, reducing manual feature engineering, enabling adaptive AI-driven analytics, and closing the loop between AI output and user actions.

The specific processing by the specific processing unit 290 of the data processing device 12 in Application Example 1 is realized by the following means.

The present invention provides a server comprising a processor and a storage device, the processor being configured to acquire human behavior information from information processing terminals and operation information from detection devices of mechanical equipment, preprocess the acquired information using a general-purpose information processing program to perform time normalization, identifier completion, classification conversion, and aggregation, and store resulting structured information in the storage device as integrated management information, to associate the structured information with human attribute information, mechanical equipment attribute information, and maintenance history information, and to compute indicators of human operation states and indicators of mechanical equipment operation states from the integrated management information, to detect, based on the indicators, targets for which fatigue-related indicators of the human and maintenance-related indicators of the mechanical equipment satisfy predetermined conditions, to generate for each target a description including past integrated management information and past result information, and to compose a prompt sentence including the description as input information for a generative AI model, to transmit the prompt sentence to the generative AI model, receive prediction information and recommendation information generated by the generative AI model based on the integrated management information and the past result information, and store the prediction information and the recommendation information in the storage device, and to generate planning information for optimizing at least one of a human work plan and a mechanical equipment maintenance plan based on the prediction information, the recommendation information, and the integrated management information, to convert the planning information into visualization information and output the visualization information to a presentation device, and to update at least part of the planning information based on user operation information received via the presentation device and record an update result as part of the integrated management information in the storage device. This enables the computer system to automatically unify heterogeneous behavioral and operational data into a consistent data model, dynamically construct context-rich prompt sentences as inputs to a generative AI model, obtain high-quality predictive and prescriptive outputs, and iteratively refine scheduling and maintenance decisions based on user feedback, thereby improving the technical performance, adaptability, and efficiency of the underlying data processing and decision-support infrastructure.

The term “system” refers to a combination of hardware and software components including at least one processor, one or more memories or storage devices, and one or more interfaces, that cooperate to execute the functions described herein.

The term “processor” refers to any hardware computing element or combination of elements, such as a central processing unit, a microcontroller, a digital signal processor, or a plurality of such units, configured to execute instructions to perform operations on data.

The term “information processing apparatus” refers to a computing platform that includes a processor, a memory, and communication interfaces, and that is configured to control acquisition, preprocessing, storage, analysis, and output of data according to programmed instructions.

The term “information processing terminal” refers to an end-user or edge device, such as a personal computer, a mobile communication device, or an industrial terminal, configured to collect data from a user or environment and communicate the collected data to the information processing apparatus.

The term “human behavior information” refers to data representing actions, activities, or usage patterns of a person, including, for example, device usage logs, application usage records, working time records, and interaction histories recorded by an information processing terminal.

The term “operation information” refers to data representing an operational state, usage, or performance of a machine or equipment, including, for example, run/stop status, runtime, sensor values, error events, and environmental conditions detected by one or more sensors.

The term “mechanical equipment” refers to any industrial or commercial machine, apparatus, or automated device used in production, logistics, or service operations, including, for example, robots, manufacturing machines, and processing devices.

The term “detection device” refers to a sensor, signal acquisition unit, controller, or combination thereof, configured to detect physical or logical states of mechanical equipment and to output corresponding operation information.

The term “storage device” refers to any non-transitory computer-readable medium, such as a semiconductor memory, a magnetic storage medium, or an optical storage medium, configured to store data and program instructions.

The term “general-purpose information processing program” refers to software instructions executable by a processor that perform data handling operations, such as parsing, transformation, aggregation, and formatting, and that are not limited to a specific hardware configuration or specific application domain.

The term “preprocess” refers to performing one or more operations on raw data, including cleaning, filtering, normalizing, transforming, aggregating, or otherwise preparing the data for subsequent analysis or storage.

The term “time normalization” refers to converting time-related data into a unified representation, such as a standardized time zone, resolution, or format, to enable consistent comparison, aggregation, and analysis.

The term “identifier completion” refers to inferring or supplementing missing or incomplete identifiers, such as user identifiers, device identifiers, or equipment identifiers, by using lookup tables, mapping rules, or contextual information.

The term “classification conversion” refers to mapping raw data elements, such as application names or status codes, into higher-level categories or classes according to predefined or learned classification rules.

The term “aggregation processing” refers to computing summary values, such as sums, averages, counts, or distributions, from multiple data records over specified intervals or groups.

The term “structured information” refers to data that has been organized into a predefined format or schema, such as records with specified fields, tables with defined columns, or objects with defined attributes, suitable for efficient querying and analysis.

The term “information storage apparatus” refers to a storage subsystem, including one or more storage devices and associated control hardware and software, configured to store and manage structured information, integrated management information, and related data.

The term “attribute information relating to a human” refers to descriptive data about a person, such as department, role, contractual working hours, or skill level, that is associated with the human behavior information.

The term “attribute information relating to the mechanical equipment” refers to descriptive data about a machine, such as model, type, rated capacity, location, or recommended maintenance interval, that is associated with the operation information.

The term “maintenance history information” refers to records of past maintenance actions performed on mechanical equipment, including maintenance dates, types of work, replaced components, and observed issues.

The term “integrated management information” refers to data created by associating and consolidating structured information with attribute information and maintenance history information into a unified data model that simultaneously represents human-related and equipment-related states.

The term “indicator of an operation state of the human” refers to a computed metric that quantitatively represents an aspect of a person's work condition, such as total working time, overtime ratio, break time, or a derived fatigue-related score.

The term “indicator of an operation state of the mechanical equipment” refers to a computed metric that quantitatively represents an aspect of a machine's condition or usage, such as runtime, utilization rate, error frequency, or a derived maintenance-related score.

The term “predetermined condition” refers to a threshold, rule, or logical combination of rules defined in advance, used to determine whether a particular indicator value or combination of indicator values satisfies a specified criterion.

The term “target” refers to an entity or set of entities, such as a specific person, a specific piece of mechanical equipment, or a combination thereof, selected based on one or more indicators satisfying a predetermined condition.

The term “past integrated management information” refers to integrated management information corresponding to time periods prior to a current analysis time, used as historical context for evaluating trends and patterns.

The term “past result information” refers to data indicating outcomes of prior events or actions, such as occurrence or non-occurrence of failures, changes in error rates, or effectiveness of prior countermeasures.

The term “description” refers to a text, structured text, or data object that explains or summarizes historical and current conditions of a target, including past integrated management information and past result information, in a form suitable for inclusion in a prompt sentence.

The term “prompt sentence” refers to a machine-readable natural language or structured textual input that encodes relevant context, data summaries, and instructions, and that is provided to a generative AI model to cause the model to perform a specified analytic or generative task.

The term “input information for a generative artificial intelligence model” refers to data, including at least one prompt sentence and optionally additional parameters or context, that is supplied to a generative AI model for processing.

The term “generative artificial intelligence model” refers to a machine learning model, such as a large language model or other generative model, configured to generate text or other output content in response to input information that includes a prompt sentence.

The term “future risk evaluation” refers to an assessment generated by the generative artificial intelligence model that estimates the likelihood and impact of undesirable future events, such as human fatigue or equipment failure, based on current and past information.

The term “countermeasure proposal” refers to a recommended action or set of actions generated by the generative artificial intelligence model that is intended to reduce, mitigate, or avoid a predicted risk.

The term “prediction information” refers to data output by the generative artificial intelligence model that represents predicted future states, probabilities of events, or expected trends for humans and mechanical equipment.

The term “recommendation information” refers to data output by the generative artificial intelligence model that specifies suggested adjustments, interventions, or plans for managing human work or mechanical equipment maintenance.

The term “planning information” refers to structured data representing an intended schedule, allocation, or sequence of actions for at least one of human work activities and mechanical equipment maintenance operations.

The term “work plan of the human” refers to a plan that specifies working times, tasks, shifts, or workload allocations for one or more persons.

The term “maintenance plan of the mechanical equipment” refers to a plan that specifies maintenance times, tasks, inspection intervals, or component replacements for one or more machines.

The term “visualization information” refers to data prepared for graphical or tabular display, such as values arranged for charts, graphs, dashboards, or reports, derived from planning information and related data.

The term “presentation apparatus” refers to an output and input device combination, such as a display terminal, a mobile device, or a workstation, configured to present visualization information to a user and receive user operation information.

The term “user operation information” refers to data representing user interactions with the presentation apparatus, such as selections, edits, confirmations, or overrides applied to planning information or visualization information.

The term “update result” refers to data reflecting changes made to planning information based on user operation information, including revised schedules, modified allocations, or newly added actions.

The term “separation risk” refers to a risk that a person will leave an organization or terminate a working relationship, estimated based on behavior information, emotion information, and other contextual data.

The term “failure risk” refers to a risk that mechanical equipment will fail, malfunction, or operate outside of acceptable performance limits, estimated based on operation information and maintenance history information.

The term “work distribution” refers to allocation of work tasks or workloads among multiple persons in order to balance or adjust their individual loads.

The term “load adjustment” refers to modification of the amount, intensity, or timing of work assigned to persons or usage imposed on mechanical equipment to reduce or redistribute stress or risk.

The term “maintenance timing” refers to a point or interval in time at which maintenance actions on mechanical equipment are scheduled or recommended to occur.

In one embodiment, a server implements the claimed system by executing a set of software modules on general-purpose computing hardware. The server includes a central processing unit (CPU), a main memory, a non-transitory storage device, and a network interface. The server executes an operating system such as a general-purpose server operating system and runs application software implemented, for example, using a programming language such as Python. The server communicates with one or more terminals and with detection devices installed on mechanical equipment over a packet-switched network using a protocol such as TCP/IP over Ethernet or wireless communication.

A terminal operates as an information processing terminal associated with a human. The terminal is realized, for example, as a personal computer, a tablet, a smartphone, or an industrial terminal. The terminal executes a client program that acquires human behavior information, such as application usage logs, input activity, and screen status, using operating system APIs. The terminal transmits the acquired human behavior information to the server using an application-layer protocol such as HTTPS. The terminal may also display visualization information and receive user operation information via a graphical user interface.

A user operates a terminal to view visualization information supplied by the server and to input user operation information, such as editing a work plan or confirming a maintenance plan. The user can, for example, interact with dashboards that show indicators of human operation states and indicators of mechanical equipment operation states, and can adjust scheduling parameters based on recommendation information.

The server acquires human behavior information from terminals and operation information from detection devices of mechanical equipment. In one embodiment, the server exposes an application programming interface (API) endpoint implemented, for example, using a web application framework. The terminals send behavior information in a structured textual form containing an identifier of the human, an identifier of the terminal, timestamps, and event types such as “application started” or “application in foreground.” Detection devices attached to mechanical equipment transmit operation information, such as runtime increments, temperature values, vibration values, and error codes, via a machine communication protocol such as MQTT or a fieldbus protocol. The server receives the operation information through a communication module that subscribes to topics from the detection devices.

The server preprocesses the acquired human behavior information and operation information using a general-purpose information processing program. In one example, the server loads raw data into an in-memory data structure represented as tables with fixed columns. The server performs time normalization by converting timestamps into a unified time zone and into a unified granularity, such as minute-level resolution. The server performs identifier completion by referencing mapping tables stored in the storage device, for example to map a terminal identifier to a human identifier or a sensor identifier to a mechanical equipment identifier. The server conducts classification conversion by mapping raw application names or machine states to higher-level categories using a predefined classification table, for example mapping multiple text editor names into a “document editing” category or mapping various error codes into a “maintenance-critical” class. The server performs aggregation processing by computing daily or hourly summaries for each human and for each piece of mechanical equipment, such as total active minutes, overtime minutes, number of error events, and cumulative runtime.

The server stores the resulting structured information in an information storage apparatus. In one embodiment, the storage apparatus is realized as a relational database system. The server writes preprocessed and aggregated records into relational tables representing, for example, human behavior per day, machine operation per day, attribute information of humans, attribute information of mechanical equipment, and maintenance history information. The server defines indices on identifiers and time fields so that subsequent queries for integrated analysis can be computed with reduced latency, thereby improving retrieval speed compared to ad hoc file-based storage.

The server generates integrated management information by associating the structured information with attribute information of humans, attribute information of mechanical equipment, and maintenance history information. In one embodiment, the server executes join operations between behavior tables and attribute tables based on human identifiers, and between operation tables and attribute tables based on mechanical equipment identifiers. The integrated management information is represented as a unified schema that contains fields for human-related metrics, machine-related metrics, and historical maintenance data for corresponding time periods. Because the integrated management information is stored in a consistent schema, the server can compute cross-domain indicators, such as a correlation between overtime levels and subsequent machine errors, without performing ad hoc transformations at query time. This reduces processing time and reduces the number of data conversion steps needed for each analysis.

The server calculates indicators of human operation states and indicators of mechanical equipment operation states from the integrated management information. For human operation states, the server computes metrics such as average working time over a rolling window, overtime ratio relative to contractual working hours, and a fatigue-related score derived from a combination of long working hours, irregular working patterns, and short break intervals. For mechanical equipment operation states, the server computes metrics such as cumulative runtime since last maintenance, utilization ratio relative to rated capacity, and a maintenance-related risk score derived from runtime, error frequency, and time elapsed since maintenance. The server stores these indicators in dedicated indicator tables so that they can be quickly accessed for risk evaluation and prompt sentence generation. The explicit representation of indicators as precomputed values allows the server to avoid repeated on-the-fly calculations, increases throughput, and reduces latency when serving multiple concurrent requests.

The server detects targets based on indicators satisfying predetermined conditions. In one embodiment, the server compares fatigue-related indicators of humans and maintenance-related indicators of mechanical equipment against threshold values defined in configuration data. The thresholds may be defined as absolute values or as relative percentages above baseline values computed over historical windows. The server selects humans whose fatigue-related indicator exceeds a “high risk” threshold and selects machines whose maintenance-related indicator exceeds a “high risk” threshold. In another embodiment, the server applies rules based on combinations of indicators, such as selecting a pair of a human and a machine when both fatigue-related and maintenance-related indicators are high for the same production line. This rule-based preselection reduces the amount of data sent to a generative AI model, thereby reducing communication load and computational burden in the AI processing.

The server generates, for each target, a description including past integrated management information and past result information. In one example, the server retrieves for each selected human the integrated management information for a past period, such as the last 30 days, and retrieves past result information such as recorded error rates or prior incidents of absenteeism. The server converts numerical sequences into summarized statistics, such as “average working time of 10.5 hours over 14 days” and “error rate increased by 20% during previous high-overtime periods.” For each selected mechanical equipment, the server retrieves integrated operation metrics and past result information such as actual failure occurrences, repair durations, and maintenance actions. The server generates textual descriptions that approximate how a human expert would summarize the situation, but the description is automatically constructed based on deterministic rules applied to the integrated management information and past result information. This automatic construction ensures that similar situations are represented in a consistent textual format, which improves the reliability and repeatability of subsequent AI analysis.

The server composes a prompt sentence including the description as input information for a generative AI model. In one embodiment, the server implements a prompt generation module that uses template-based composition. The module inserts descriptive phrases into a template that includes explicit instructions to the generative AI model regarding the type of analysis to be performed. For example, the server may generate the following prompt sentence:
“Employee E123 in the assembly group has worked an average of 10.5 hours per day over the last 14 days. The standard shift length is 8 hours, so overtime exceeds 30 percent of normal working hours. Past records show that when overtime stays above 25 percent for more than 10 days, the error rate increased by approximately 20 percent. Machine RobotA on the same line has a runtime that is 20 percent higher than its three-month historical average over the past 30 days. The last maintenance for RobotA was performed 120 days ago, while the recommended interval is 90 days. Based on these data and similar past cases, estimate the current risk of employee fatigue for E123 and the probability that RobotA will require maintenance or fail within the next two weeks, and provide concrete recommendations for schedule adjustments and maintenance timing.”

By including specific numerical values, historical patterns, and explicit instructions, the prompt sentence encodes context in a structured way. This allows the generative AI model to perform targeted analysis that would be difficult to replicate with fixed feature vectors alone. The server can vary the template according to different use cases, such as emphasizing human fatigue risk, machine failure risk, or combined risk scenarios.

The server transmits the prompt sentence to a generative AI model implemented, for example, as a large-scale neural network hosted on a separate AI server or as a service in a distributed computing environment. In one embodiment, the generative AI model is a transformer-based neural network trained on a large corpus of text and additional domain-specific logs. The transformer model comprises multiple layers of self-attention mechanisms, feed-forward networks, and layer normalization modules. The server sends the prompt sentence as input tokens, which are embedded into continuous vectors and processed by the successive transformer layers. During training, the model parameters, such as weight matrices in attention modules and feed-forward layers, have been adjusted by minimizing a loss function, such as cross-entropy loss, using backpropagation and gradient-based optimization. The model has learned to represent complex temporal and causal relationships between textual descriptions and subsequent outcomes.

In an alternative embodiment, the server uses a generative AI model fine-tuned specifically on integrated management information and past result information. The fine-tuning dataset consists of prompt sentences constructed from historical data and target outputs consisting of known risks and effective countermeasures. The fine-tuning process involves additional training epochs in which model weights are updated to minimize prediction error on domain-specific tasks. This configuration improves the accuracy of risk evaluation and recommendations compared to a generic model that has not been adapted to the integrated management information.

The server receives prediction information and recommendation information generated by the generative AI model. In one embodiment, the generative AI model outputs a structured textual response that includes predicted risk levels, probability ranges, and specific recommended actions. The response may follow a constrained format enforced by instructions in the prompt sentence, such as numbering items or providing values in a list. The server parses the response by recognizing the structured format and extracts fields such as a fatigue risk category, an estimated failure probability, and specific scheduling advice. The server stores the prediction information and recommendation information as structured records in the storage device. Because the model output is constrained by the prompt structure, the parsing process can be implemented using deterministic rules instead of complex natural language understanding, reducing error and processing overhead.

The server generates planning information for optimizing at least one of a human work plan and a mechanical equipment maintenance plan based on the prediction information, the recommendation information, and the integrated management information. In one embodiment, the server uses a planning module that combines AI-generated recommendations with system constraints, such as maximum allowable overtime, minimum rest periods, machine availability windows, and production requirements. The planning module uses algorithms such as linear optimization or greedy scheduling to reconcile conflicting constraints while aligning with AI recommendations. For example, if the generative AI model recommends reducing working hours for a particular human and performing maintenance on a machine within a certain time window, the planning module will compute specific dates and times in which shifts are adjusted and maintenance tasks are scheduled. This automated planning based on AI output and integrated constraints reduces the number of iterations needed to obtain a feasible plan, thereby improving the efficiency of the planning process.

The server converts the planning information into visualization information and outputs the visualization information to a presentation apparatus. In one embodiment, the server generates a set of data structures representing charts, timelines, and tables that a visualization component can render. The visualization information includes, for example, a timeline for each human indicating planned shifts, a timeline for each mechanical equipment indicating planned maintenance, and color-coded risk levels before and after applying the plan. A terminal functioning as a presentation apparatus displays these visualizations through a graphical interface that supports panning, zooming, filtering, and selection. Because planning information is stored in a normalized form, the server can generate visualization information with fewer database queries compared to systems that recompute planning metrics from raw logs on each request. This improves response time and interactivity for the user.

The server updates at least part of the planning information based on user operation information received via the presentation apparatus and records an update result as part of the integrated management information in the storage device. A user can, for example, accept some recommended changes, override others, or specify additional constraints, such as a specific day on which maintenance cannot be performed. The terminal sends these user operation events to the server, which updates the relevant records in the planning tables and logs the changes in an action log associated with the integrated management information. By feeding user adjustments back into the integrated management information, the system maintains a closed loop where subsequent analyses can consider both AI-generated recommendations and actual decisions taken. This feedback loop allows the server to later construct prompt sentences that incorporate outcome data, such as “previously, when we reduced overtime according to a similar recommendation, error rates decreased by 15 percent,” thereby enabling the generative AI model to refine its future predictions.

From a technical perspective, the described configuration yields improvements to computer technology beyond mere automation of human decision-making. By unifying heterogeneous behavior and operation data into integrated management information with a consistent schema, the server reduces the number of data transformations required at query time, which improves cache locality and reduces memory usage during analysis. By precomputing indicators and using rule-based selection of targets, the server reduces the volume of data transmitted to the generative AI model and the number of AI inferences, thereby lowering communication load and inference latency. By employing template-based prompt sentence generation that encodes quantitative patterns and historical outcomes, the server enables the generative AI model to perform more accurate risk estimation without requiring hand-crafted feature engineering for each new pattern. This design improves prediction accuracy and reduces the need to reprogram rule sets when new types of patterns appear.

Furthermore, the server uses a training and fine-tuning method for the generative AI model that directly incorporates integrated management information and past result information. The learning process uses objective functions that penalize incorrect risk levels and ineffective countermeasure proposals, and updates model weights through gradient-based optimization. As a result, the generative AI model develops internal representations that are specifically adjusted to the unified data model and to the risk assessment task, which increases prediction precision compared to generic models. The system's architecture also decouples raw data preprocessing from prompt sentence construction, allowing each module to be optimized independently and enabling deployment on distributed computing platforms where preprocessing nodes and AI inference nodes are scaled separately.

In alternative embodiments, the server replaces or supplements the transformer-based generative AI model with other architectures, such as recurrent neural networks or hybrid models that combine attention mechanisms with graph-based encoders that explicitly model relationships between humans, machines, and maintenance events. In another variation, the server computes additional features, such as frequency-domain features derived from sensor signals or anomaly scores from unsupervised models, and encodes these features into prompt sentences as textual descriptions like “vibration pattern deviates from baseline by X standard deviations.” These variations illustrate that the inventive concept can be realized with different AI architectures and feature sets, while maintaining the same underlying approach of integrated data modeling, structured prompt sentence generation, and AI-driven planning.

In all these embodiments, the server implements a specific data flow and module composition that transforms raw heterogeneous data into integrated management information, generates structured prompt sentences, interacts with a generative AI model under constrained formats, and converts prediction information and recommendation information into actionable planning information with user-feedback integration. This configuration achieves technical effects such as reduced data processing latency, improved prediction accuracy, improved consistency of AI inputs and outputs, reduced communication load between components, and enhanced robustness of the overall decision-support pipeline.

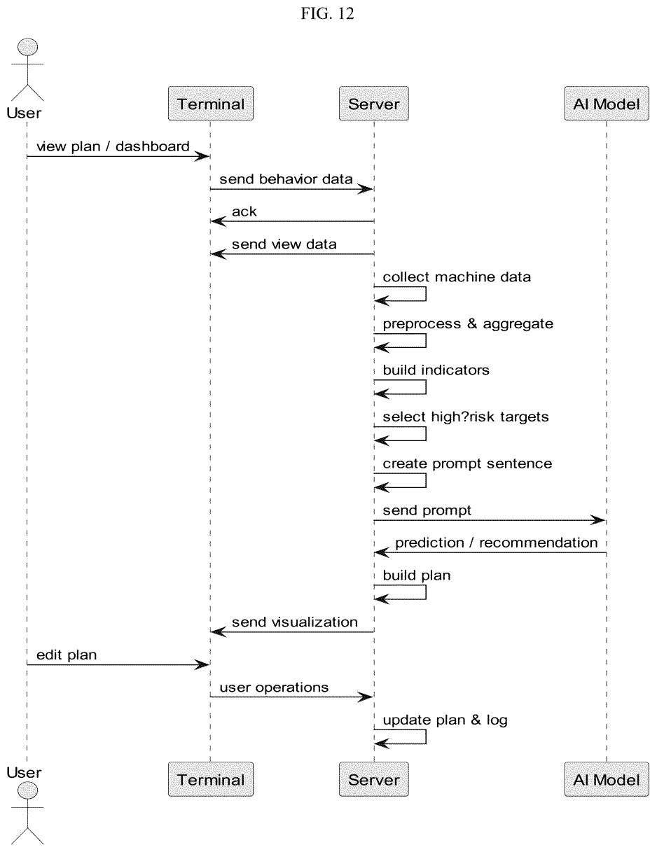

The following describes the processing flow using FIG. 12.

### Step 1:

Server receives human behavior information from terminals.
Server takes, as input, behavior events transmitted from each terminal, including terminal identifiers, human identifiers, timestamps, application names, and activity types such as “app_start,” “app_focus,” and “screen_lock.”
Server validates each received record by checking required fields, timestamp format, and identifier format, and discards or logs inconsistent records.
Server converts valid records into an internal event structure and writes them into a raw behavior table in a storage device, so that later modules can load the events in a uniform schema.

### Step 2:

Terminal acquires behavior events and transmits them to the server.
Terminal takes, as input, operating system events indicating foreground application changes, input device activity, and session status.
Terminal uses system APIs to read the current active application, to detect when the screen locks or unlocks, and to timestamp these events.
Terminal aggregates these low-level OS events into higher-level behavior records, for example combining consecutive intervals of the same application into a single usage segment, and sends a message containing these segments to the server via a secure communication channel.

### Step 3:

Server acquires operation information from detection devices of mechanical equipment.
Server takes, as input, sensor messages transmitted from detection devices, including equipment identifiers, runtime increments, status flags, sensor readings, and timestamps.
Server parses each message to extract numeric values and status indicators, converts units if necessary, and maps raw sensor identifiers to logical equipment identifiers using a mapping table.
Server writes the parsed and mapped data into a raw operation table in the storage device, preserving original timestamps so that subsequent processing can reconstruct detailed time series.

### Step 4:

Server preprocesses raw behavior and operation data into structured information.
Server takes, as input, raw behavior records from the raw behavior table and raw operation records from the raw operation table.
Server performs time normalization by converting all timestamps to a unified time zone and rounding or interpolating them to a fixed time granularity, such as one-minute or five-minute intervals.
Server performs identifier completion by joining raw records with mapping tables that associate device identifiers with human identifiers and sensor identifiers with equipment identifiers, filling missing identifiers based on known relationships.
Server performs classification conversion by mapping application names and equipment status codes to higher-level categories stored in a classification table, for example mapping various editor applications to a “documentation” class and different error codes to a “critical_error” class.
Server computes aggregated metrics per human and per equipment over specified periods, such as daily total active time, daily overtime minutes, daily runtime minutes, and error event counts, and stores the resulting structured information in behavior summary tables and operation summary tables.

### Step 5:

Server associates structured information with attribute and maintenance history information to create integrated management information.
Server takes, as input, behavior summaries, operation summaries, human attribute records, equipment attribute records, and maintenance history records.
Server executes join operations keyed by human identifiers and equipment identifiers to merge summaries with attribute data, and uses temporal joins to link operation summaries with relevant maintenance records based on dates.
Server calculates derived fields, such as time since last maintenance, runtime since last maintenance, contractual working hours per human, and deviations from nominal parameters, and stores these combined and derived fields in an integrated management table that represents both human and equipment states for each period.

### Step 6:

Server calculates indicators of human operation states and indicators of mechanical equipment operation states.
Server takes, as input, the integrated management table for a configurable analysis window, such as the past 7, 14, or 30 days.
Server computes rolling averages, sums, and ratios, such as average daily working hours, overtime ratios, break frequency for each human, and average daily runtime, error rates, and utilization ratios for each equipment.
Server combines multiple base metrics using predefined formulas or weighting schemes to derive scalar indicators such as a “fatigue score” for humans and a “maintenance risk score” for equipment, and stores these indicators in dedicated indicator tables indexed by human identifier, equipment identifier, and date.

### Step 7:

Server detects high-risk targets based on predetermined conditions.
Server takes, as input, the indicator tables containing fatigue scores and maintenance risk scores, along with configuration data specifying threshold values and rule sets.
Server applies comparison operations to identify humans whose fatigue scores exceed defined thresholds and equipment whose maintenance risk scores exceed defined thresholds, and evaluates compound rules that may depend on multiple indicators or joint conditions across human and equipment entities.
Server outputs a list of high-risk targets, each containing identifiers, relevant indicators, and references to associated integrated management records, and stores this list in a target selection table for subsequent analysis.

### Step 8:

Server constructs descriptions and generates prompt sentences for each selected target.
Server takes, as input, the list of high-risk targets, associated integrated management information over a historical window, and past result information indicating prior failures, incidents, or changes in error rates.
Server summarizes numerical histories into text fragments, for example computing that “average working time was 10.5 hours per day over the last 14 days” or “runtime increased by 20 percent compared to the three-month historical average,” by calculating averages, percentages, and differences and formatting them as human-readable expressions.
Server places these text fragments into pre-defined templates that also include explicit instructions for analysis, thereby generating a prompt sentence for each target.
Server outputs, for each target, a prompt sentence that encodes both data-derived descriptions and analysis instructions, such as:
“Employee E123 in the assembly group has worked an average of 10.5 hours per day over the last 14 days. The standard shift length is 8 hours, so overtime exceeds 30 percent of normal working hours. Past records show that when overtime stays above 25 percent for more than 10 days, the error rate increased by approximately 20 percent. Machine RobotA on the same line has a runtime that is 20 percent higher than its three-month historical average over the past 30 days. The last maintenance for RobotA was performed 120 days ago, while the recommended interval is 90 days. Based on these data and similar past cases, estimate the current risk of employee fatigue for E123 and the probability that RobotA will require maintenance or fail within the next two weeks, and provide concrete recommendations for schedule adjustments and maintenance timing.”

### Step 9:

Server sends prompt sentences to the generative AI model and receives prediction and recommendation information.
Server takes, as input, the generated prompt sentences and configuration parameters for the generative AI model, such as maximum output length and response style constraints.
Server encodes each prompt sentence into request messages and transmits these messages via a network interface to an AI inference service that hosts a generative AI model, for example a transformer-based large language model.
Server receives, as output, textual responses from the generative AI model, where each response contains predicted risk levels, probability estimates, and recommended actions according to the instructions in the corresponding prompt sentence.
Server parses the responses using pattern-based extraction, such as recognizing numbered items and labels, and converts the textual content into structured prediction information and recommendation information, which are then stored in AI output tables linked to the corresponding targets.

### Step 10:

Server generates planning information based on prediction information, recommendation information, and integrated management information.
Server takes, as input, AI output tables, integrated management information, and operational constraints such as maximum overtime per human, minimum rest intervals, and allowed maintenance windows for equipment.
Server maps AI recommendations into candidate plan modifications, for example by proposing reduced shift lengths for specific humans or scheduling maintenance tasks within recommended time windows.
Server applies a planning algorithm that considers all constraints and candidate modifications, evaluates feasibility, and resolves conflicts, for example by shifting tasks between humans or adjusting maintenance dates within an acceptable range.
Server outputs detailed planning records specifying updated work schedules and maintenance schedules, and stores these records in planning tables associating each human and each piece of equipment with specific planned actions and times.

### Step 11:

Server converts planning information into visualization information and delivers it to terminals.
Server takes, as input, planning tables and relevant indicators, such as current risk scores and predicted risk reductions after plan application.
Server transforms planning records into structures suitable for rendering visual elements, such as timelines, bar charts, and heatmaps, by grouping and ordering records by time, human, and equipment, and by assigning visual attributes such as colors for different risk levels.
Server sends the visualization information to terminals, which receive and display interactive dashboards or screens where a user can inspect planned shifts, planned maintenance tasks, and associated risk indicators.

### Step 12:

User reviews visualization information and inputs operation information to adjust the plan.
User observes, as input, the visualized planning information on a terminal, including schedules, risk scores, and AI-generated recommendations.
User performs interactive operations, such as selecting specific humans or equipment, modifying scheduled times, accepting or rejecting suggested actions, and applying additional constraints through the user interface.
Terminal captures these user interactions as user operation information, such as updated dates and times or status flags, and transmits the user operation information back to the server for processing.

### Step 13:

Server updates planning information based on user operation information and records update results into integrated management information.
Server takes, as input, user operation information indicating changes to planning records, such as new shift boundaries, cancelled maintenance tasks, or rescheduled maintenance dates.
Server applies the requested changes to the planning tables, verifies that updated plans still satisfy hard constraints, and adjusts related entries if necessary, such as updating linked tasks or recalculating expected coverage.
Server records the update results, including original values, new values, timestamps, and user identifiers, in an action log that is associated with the integrated management information.
Server incorporates these update results into the integrated management information for future analyses, enabling subsequent prompt sentences and interactions with the generative AI model to consider actual decisions and outcomes.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional employee management systems typically collect attendance logs and performance records and present simple statistics or threshold-based alerts. However, such systems are limited to rule-based evaluation, require manual configuration of criteria, and do not adapt to complex, time-varying behavioral patterns. As a result, it is difficult for such systems to accurately predict future work-related problem events, such as delays, attendance irregularities, minor errors, and loss of concentration, in a timely manner.

In addition, existing predictive systems that apply machine learning often operate as opaque batch processes. These systems generally lack a unified mechanism for (i) systematically transforming raw behavioral data into reusable feature representations, (ii) dynamically generating explanatory content and countermeasure proposals, and (iii) integrating model outputs with human-understandable narratives. Consequently, users are forced to interpret numerical risk scores without sufficient context, which impairs their ability to decide effective interventions and allocate resources optimally.

Furthermore, conventional uses of generative AI models in enterprise contexts are frequently ad hoc: users issue free-form queries, and the model responds without being tightly coupled to structured prediction pipelines. This separation leads to incomplete or inconsistent use of available data, difficulty in reproducing analyses, and inefficiencies in workflow. There is no standardized, processor-controlled mechanism to construct prompt sentences that consistently embed up-to-date feature values, risk indices, and model performance information into the interaction with a generative AI model.

Moreover, known systems do not provide an integrated architecture in which a processor automatically (i) collects behavior information from heterogeneous management systems via a communication network, (ii) performs standardized preprocessing operations, (iii) trains, evaluates, and updates a prediction structure representing relationships between behavior patterns and problem events, (iv) computes resource allocation plans based on risk indices and generated explanatory information, and (v) renders such plans and explanations as interactive visualizations on a terminal device. This lack of integration limits scalability, reproducibility, and the overall technical performance of the computer-based analysis.

The technical problem to be solved, therefore, is to improve computer technology for employee-related risk prediction and resource planning by providing an automated, processor-implemented pipeline that transforms raw behavioral information into structured feature values, uses a prediction structure in conjunction with a generative AI model through systematically constructed prompt sentences, and outputs machine-generated, context-aware explanations and countermeasure proposals in a form that is directly consumable by users through a visualization interface. By addressing this problem, the invention aims to enhance the efficiency, accuracy, and interpretability of computer-implemented analysis of work-related risks, and to enable more reliable and timely resource allocation decisions.

The specific processing by the specific processing unit 290 of the data processing device 12 in Example 2 is realized by the following means.

The present invention provides a server comprising a processor, a storage device, and a display control device, the processor being configured to acquire behavioral information of work entities from at least one work-related information management device via a communication network and store the behavioral information in the storage device; execute preprocessing on the behavioral information, the preprocessing including missing-value correction, outlier removal, and numerical conversion, and calculate aggregated indices for each work entity and for each predetermined period to generate a group of feature values; execute a learning process using the group of feature values and post-occurrence event information corresponding to the group of feature values to generate and store a prediction structure that represents a relationship between behavioral patterns and work-related problem events; apply the preprocessing to latest behavioral information to generate an inference-use group of feature values, input the inference-use group of feature values to the prediction structure, and calculate occurrence probabilities and risk indices of the work-related problem events; construct, based on the inference-use group of feature values and the risk indices, a generation input text including analysis request content, generate a prompt sentence for transmitting the generation input text to a generative information processing model, and acquire response information including explanatory information and countermeasure information from the generative information processing model; aggregate the risk indices and the response information to calculate resource allocation plan information for each work entity and for each organizational unit; and cause the display control device to provide, to a terminal device, visualization information including the resource allocation plan information, the risk indices, and the response information and to accept countermeasure planning operations from a user. This enables a computer system to automatically transform heterogeneous raw behavioral information into standardized feature values, maintain and apply an adaptive prediction structure, systematically generate and manage prompt sentences for interaction with a generative AI model, and deliver integrated, machine-generated risk analyses and resource allocation proposals in an interactive visual form, thereby improving the technical performance, scalability, and interpretability of computer-implemented risk prediction and resource management.

The term “work entity” refers to an abstract unit representing a subject of work-related analysis, including but not limited to an individual worker, a group of workers, a team, a department, or any other organizational unit for which behavioral information is collected and evaluated.

The term “behavioral information” refers to data representing actions, statuses, or performance of a work entity in connection with work activities, including but not limited to attendance records, task execution logs, delay events, error occurrences, and indicators of concentration or engagement.

The term “work-related information management device” refers to an information processing apparatus or service that records, manages, or exposes behavioral information or related operational data of work entities, such as an attendance management system, a task management system, or a performance tracking system.

The term “communication network” refers to any wired or wireless data transmission infrastructure that enables data exchange between the server, the work-related information management device, and one or more terminal devices, including but not limited to local area networks and wide area networks.

The term “storage device” refers to a physical or logical data storage component accessible by the processor, including but not limited to a magnetic disk device, a solid-state storage device, or a network-based storage system, that stores behavioral information, feature values, prediction structures, and related data.

The term “display control device” refers to a hardware and/or software component that controls output of visual information to a terminal device, including but not limited to a graphics processing unit, a display driver, or a server-side rendering module.

The term “terminal device” refers to an information processing endpoint operated by a user, including but not limited to a personal computer, a portable terminal, or a network-enabled display device capable of presenting visualization information and receiving user input.

The term “preprocessing” refers to a set of computational operations applied to raw behavioral information to improve data quality and suitability for machine learning, including but not limited to missing-value correction, outlier removal, scaling, normalization, and numerical encoding.

The term “missing-value correction” refers to processing that detects absent or undefined data elements in behavioral information and replaces such elements with substitute values, such as statistical estimates or default values, to maintain consistency of data records.

The term “outlier removal” refers to processing that identifies and excludes data elements whose values deviate from expected ranges or statistical distributions beyond a predetermined threshold, in order to reduce the influence of anomalous records on subsequent analysis.

The term “numerical conversion” refers to processing that transforms non-numeric or heterogeneous data elements, such as categorical attributes or textual indicators, into numeric representations suitable for computational analysis and machine learning.

The term “aggregated index” refers to a numerical measure computed by combining multiple behavioral data points over a predetermined period or group, such as a count, sum, average, ratio, or other statistical value representing the behavior of a work entity.

The term “group of feature values” refers to a collection of numerical or encoded variables derived from behavioral information and aggregated indices, structured so as to be used as input to a prediction structure or other computational model.

The term “post-occurrence event information” refers to data indicating whether and how a particular work-related problem event occurred after a given observation period, including labels or outcome indicators used as supervisory signals in a learning process.

The term “work-related problem event” refers to an undesired or adverse event associated with work activities of a work entity, including but not limited to delays, attendance irregularities, minor errors, productivity loss, or concentration issues.

The term “learning process” refers to a computational procedure in which a prediction structure is generated or updated by optimizing parameters based on training data that includes a group of feature values and corresponding post-occurrence event information.

The term “prediction structure” refers to a data representation or computational model obtained through the learning process, which expresses relationships between behavioral patterns of work entities and work-related problem events, and which is usable to infer occurrence probabilities or risk indices.

The term “inference-use group of feature values” refers to a set of feature values derived from latest behavioral information and formatted in accordance with the input requirements of the prediction structure, for the purpose of generating predictions or risk indices.

The term “occurrence probability” refers to a value, typically numerical, that indicates a likelihood that a particular work-related problem event will occur for a work entity within a future time frame, as output by the prediction structure.

The term “risk index” refers to a quantitative indicator derived from predictions or other analytical measures that represents a level of risk associated with a work-related problem event for a work entity.

The term “analysis request content” refers to a specification of one or more analytical operations to be performed by a generative information processing model, including but not limited to explanation generation, risk interpretation, and countermeasure proposal based on supplied data.

The term “generation input text” refers to textual data, including analysis request content and contextual information such as feature values and risk indices, which is formed as input to a generative information processing model.

The term “prompt sentence” refers to a textual instruction or query, possibly including structured or summarized data, constructed by the processor for submission to a generative information processing model to control or condition its output.

The term “generative information processing model” refers to a model, typically based on machine learning, that receives a prompt sentence or generation input text and outputs generated content such as natural-language text, explanations, or recommendations.

The term “response information” refers to data returned by the generative information processing model in response to a prompt sentence, including but not limited to explanatory information, countermeasure information, and other generated text or structured outputs.

The term “explanatory information” refers to part of the response information that describes, interprets, or clarifies factors contributing to risk indices, occurrence probabilities, or other analytical results.

The term “countermeasure information” refers to part of the response information that specifies suggested actions, plans, or strategies for mitigating, preventing, or managing work-related problem events.

The term “resource allocation plan information” refers to data representing computed distributions or adjustments of resources, such as time, personnel, or workload, among work entities or organizational units, derived from risk indices and response information.

The term “organizational unit” refers to a logical or physical subdivision of an organization, including but not limited to a team, a department, a division, or a project group, for which aggregated analysis and planning are performed.

The term “visualization information” refers to data formatted or arranged for visual presentation on a terminal device, including but not limited to charts, graphs, tables, indicators, and highlighted elements representing risk indices, resource allocation plans, and related content.

The term “countermeasure planning operation” refers to an interaction performed by a user through a terminal device, including but not limited to selection, modification, or confirmation of proposed actions or resource allocations, in view of visualization information and response information.

The term “performance index” refers to a metric computed for evaluating the quality or effectiveness of the prediction structure, including but not limited to accuracy, precision, recall, or other statistical measures of predictive performance.

The term “structural element” refers to a component or configuration parameter of the prediction structure or learning process, such as a type or number of layers, nodes, connections, or hyperparameters that define the behavior of the prediction structure.

The term “learning condition” refers to a parameter or rule that governs the execution of the learning process, including but not limited to learning rate, batch size, number of epochs, stopping criteria, or regularization strength.

The term “emotion-related information” refers to data indicative of emotional states or affective conditions of a work entity, including but not limited to self-reported sentiment scores, survey results, communication-derived sentiment, or other signals of emotional tendency.

The term “risk evaluation index” refers to a numerical or categorical indicator representing an assessment of risk associated with a particular outcome or condition for a work entity, derived from analysis by the prediction structure, the generative information processing model, or both.

The term “separation possibility index” refers to a specific type of risk evaluation index indicating a likelihood that a work entity, such as an individual worker, will separate from an organization, including but not limited to resignation or disengagement.

In one embodiment, a server, a plurality of terminal devices, and one or more work-related information management devices are interconnected via a communication network. The server includes at least one processor, a main memory, a non-volatile storage device such as a solid-state drive, and a network interface. The terminal includes a processor, a memory, a display unit, and an input interface such as a keyboard, a pointing device, or a touch panel. The work-related information management device includes at least a processor, a storage unit, and an application that manages work-related data such as attendance logs and task execution records.

The server executes an operating system such as a general-purpose server operating system and middleware such as a web server process and an application server process. The server runs application software implemented, for example, using a programming language and libraries including a data processing library (for example, a tabular data processing library such as pandas), a numerical computation library (for example, a linear algebra library such as NumPy), and a machine learning framework (for example, a neural network framework such as TensorFlow or Keras) installed on the server. The server also uses a database management system such as a relational database engine (for example, PostgreSQL or MySQL) executed either on the same hardware or on a separate storage server. The terminal executes a web browser application such as a standard hypertext rendering application supporting script execution, or a dedicated native client application.

The server acquires behavioral information of work entities by communicating with one or more work-related information management devices over the communication network. The work-related information management device exposes an application programming interface using a standard communication protocol. The server sends structured requests through the network interface and receives behavioral information in a structured data format such as a record-oriented format. The server parses the received data and stores each record in the storage device using the database management system. The server associates each record with a work entity identifier, a time stamp, and one or more fields such as attendance status, delay duration, number of task errors, and concentration-related flags.

The server executes preprocessing on the behavioral information to generate a group of feature values. The server applies missing-value correction by computing replacement values such as means or medians of each numeric attribute and storing the corrected values in memory. The server applies outlier removal by computing, for each numeric attribute, statistical descriptors such as mean and standard deviation, then comparing each value with a threshold, and marking values exceeding the threshold as outliers. The server either excludes outlier records from further processing or replaces the outlier values with bounded values.

The server executes numerical conversion on non-numeric attributes, such as categorical attributes representing departments or job types, by assigning numerical identifiers or using an encoding scheme such as one-hot encoding. The server writes the numerically converted records back to the database in a normalized schema.

The server calculates aggregated indices for each work entity and each predetermined period. For example, the server uses a time window of one week or one month and groups behavioral information by the work entity identifier and the time window. The server calculates aggregated indices such as a total count of delay events, an average difference between scheduled start time and actual start time, a total count of minor errors recorded in that period, an average task completion time, and a variance of work hours. The server writes the aggregated indices as structured rows in a feature table, each row including a feature vector representing the behavior of a work entity during a particular period.

The server executes a learning process using the group of feature values and post-occurrence event information. The server obtains a label for each feature vector, indicating whether a work-related problem event occurred in a subsequent period. The server arranges the feature vectors as input tensors and the labels as output tensors and loads them into the memory of a processing unit such as a central processing unit and optionally a graphics processing unit.

The server constructs a prediction structure using the machine learning framework. In one embodiment, the server defines a neural network having an input layer whose dimension equals the number of feature values, multiple hidden layers each including a predetermined number of units with a nonlinear activation function such as a rectified linear unit, and an output layer including one or more units with a logistic or softmax activation. The server initializes weight parameters of the neural network using a random initialization method and defines a loss function such as binary cross entropy or categorical cross entropy depending on the type of labels. The server defines an optimization algorithm such as a stochastic gradient descent method with momentum or an adaptive gradient algorithm.

The server performs the learning process by repeatedly updating the weight parameters. The server divides the feature vectors into mini-batches and, for each mini-batch, computes a forward pass that propagates the input through the neural network layers to obtain predicted outputs. The server computes a loss value by comparing predicted outputs with labels, computes gradients of the loss with respect to the weight parameters using backpropagation, and updates the parameters in the direction that reduces the loss. The server repeats these operations for multiple epochs until a stopping condition is satisfied, such as a convergence threshold on validation loss or a maximum epoch count.

The server calculates one or more performance indices for the prediction structure, such as accuracy, precision, recall, F1-score, or an area under the receiver operating characteristic curve, using a held-out validation dataset. The server stores the resulting prediction structure as model parameters and architecture definition data in the storage device, together with metadata describing the feature schema, training conditions, and performance indices. By performing this structured learning process with explicit feature encoding and parameter updates, the server improves predictive accuracy and reduces sensitivity to outliers compared to simple rule-based methods.

The server applies the preprocessing to latest behavioral information to generate an inference-use group of feature values. The server ensures that the same missing-value correction rules, outlier handling thresholds, and numerical conversion mappings used during training are applied to the new data by retrieving the corresponding configurations from the storage device. The server groups the latest behavioral information by work entity and time window and produces feature vectors that match the dimensionality and ordering used for training.

The server inputs the inference-use group of feature values to the stored prediction structure and calculates occurrence probabilities and risk indices. The server performs a forward pass through the neural network for each feature vector, obtains predicted probabilities for one or more work-related problem events, and stores these probabilities as risk indices in the database. The server can also derive composite risk indices by combining multiple predicted probabilities or by applying predetermined weighting factors.

The server constructs a generation input text including analysis request content, based on the inference-use group of feature values and the risk indices. The server retrieves, for a specific work entity or group of work entities, the feature values, the risk indices, and optionally other derived indicators such as trend information over multiple time windows. The server formats this information as natural language sentences or structured text, for example, by constructing sentences such as “The work entity has been late six times in the last three months, with an increasing trend in the last four weeks, and currently has a predicted probability of 0.65 for tardiness next month.”

The server then generates a prompt sentence for transmitting the generation input text to a generative information processing model. The server concatenates the generation input text with an explicit instruction phrase describing the desired type of output. For example, the server generates a prompt sentence such as:
“Based on the past one year of attendance data and current prediction scores, explain why Employee A has a high risk of tardiness next month and propose specific countermeasures.” or
“Using the last 12 months of behavior data, list the top 10 employees with the highest predicted risk of work delays next quarter and propose prioritized intervention plans.”

The server sends the prompt sentence to an external or internal generative AI model through a network-based application programming interface. The generative AI model may be an autoregressive language model or a sequence-to-sequence neural network trained on large-scale text data, executed on a separate computing environment. The server encapsulates the prompt sentence in an API request, transmits it over the communication network, and receives response information including explanatory information and countermeasure information.

The server aggregates the risk indices and the response information and calculates resource allocation plan information. For example, the server evaluates, across all work entities in a department, the predicted risk indices for tardiness and work delays, and uses these values as inputs to an optimization procedure that determines how to distribute workload hours, shift allocations, or training resources. The server may implement a heuristic or algorithmic procedure such as a linear programming solver or a greedy assignment algorithm, with a constraint that overall capacity is fixed. The server computes an assignment plan that minimizes a function of predicted risk and resource cost, and stores this resource allocation plan information in the database.

The server causes the display control device to provide visualization information to the terminal. The server generates visualization data structures such as time-series arrays for risk indices, rankings of work entities by predicted risk, and tables of resource allocation suggestions. The server formats this data for a front-end application by generating structured responses that contain labels, numeric values, and layout hints.

The terminal receives the visualization information via the communication network. The terminal executes a browser program or native client that renders interactive user interfaces. The terminal draws charts, graphs, and tables on the display unit using a scripting environment and a visualization library, so that a user can observe changes in risk indices over time, compare different organizational units, and inspect suggested resource allocation plans.

The terminal accepts countermeasure planning operations by the user via input devices. The user interacts with the display, for example by selecting particular work entities, adjusting parameters of the resource allocation plan, or confirming recommended actions. The terminal transmits user inputs to the server, which may then recalculate risk indices or resource allocation plans, or may generate new prompt sentences for the generative AI model that reflect the updated context.

The server also uses the performance indices of the prediction structure to adapt the learning process. For instance, when validation performance drops below a threshold or when drift in behavioral patterns is detected by monitoring changes in feature distributions, the server modifies structural elements such as the number of hidden layers, the number of units per layer, or the choice of activation function, and modifies learning conditions such as learning rate, batch size, or regularization strength. The server generates a prompt sentence that instructs the generative information processing model to analyze the updated prediction structure and explain performance changes. For example, the server can form a prompt sentence such as:
“Analyze the current prediction model for work-related delays, whose validation accuracy decreased from 0.85 to 0.78 after the last three months of data, and suggest feature engineering or model architecture modifications that can improve performance.”

By integrating explicit monitoring of model performance with structured adaptation and prompt generation, the server improves the robustness and interpretability of the prediction structure and reduces computational waste associated with uninformative retraining.

The server may incorporate emotion-related information into the feature values. For example, the server acquires sentiment scores from periodic surveys or from processed communication logs. The server numerically encodes sentiment features such as average sentiment score, volatility of sentiment, and frequency of negative responses, and combines them with behavioral features in the feature vector. The server then trains and applies the prediction structure to calculate a separation possibility index representing likelihood of resignation or disengagement. The server generates a prompt sentence that instructs the generative AI model to present the basis of calculation for the separation possibility index and to propose preventive measures. An example prompt sentence is:
“Using behavioral and sentiment data for Employee A over the last 12 months, explain the main factors contributing to a high separation risk score and recommend specific actions to retain this employee.”

This combination of behavioral and emotion-related features allows the server to produce more accurate and earlier detection of separation risk than systems relying solely on human inspection or simple rule sets.

The described architecture and data processing pipeline result in technical improvements beyond mere automation of human judgment. The server uses standardized data structures for feature vectors, structured machine learning training with continuous parameter optimization, and systematic prompt generation that embeds machine-generated risk indices and feature summaries into interactions with a generative AI model. By doing so, the server reduces redundant data transfer between components, minimizes the need for human manual configuration of rules, and improves computational efficiency because the generative AI model receives compact, pre-aggregated, and context-rich input rather than raw logs.

The server thereby achieves faster generation of explanations and resource plans compared to a naive approach that would transmit large amounts of unstructured behavioral data directly to a generative AI model for all analysis. The preprocessing and feature aggregation reduce data dimensionality, which cuts down on communication load and memory footprint. The prediction structure filters information by computing precise risk indices, so that only high-value, representative summaries are included in the prompt sentence. This design improves end-to-end throughput and response latency when compared to conventional systems.

The server further improves technical accuracy because the prediction structure is trained with explicit loss functions and gradient-based learning, permitting fine-grained calibration of probabilities. This calibration yields risk indices that have quantifiable error bounds, which improves the reliability of subsequent resource allocation algorithms. The systematic integration of these calibrated indices into prompt sentences also allows the generative AI model to produce explanations that correspond closely to underlying numerical evidence, reducing inconsistency and ambiguity in generated recommendations.

The server implements processing rules and sequences that are not customary in purely manual operations. For example, the server automatically synchronizes the feature extraction pipeline with updates to the prediction structure, ensuring that input distributions remain consistent; the server generates prompt sentences with predetermined templates that embed structured numerical values and trends; the server monitors drift and updates model architectures based on technical performance indices. These operations are based on explicit algorithmic criteria and data structures, not on ad hoc human judgment, and thus constitute specific, computer-implemented techniques for improving predictive modeling and explanation generation.

In alternative embodiments, the server may implement other types of prediction structures, such as gradient boosting ensembles or recurrent neural networks that process sequences of behavioral events. The server may also employ different optimization algorithms or regularization techniques to improve generalization. The core functions of data acquisition, preprocessing, feature generation, model training and inference, prompt sentence construction, generative response acquisition, and visualization remain similar across such variations.

In another embodiment, the server may deploy the prediction structure and the generative AI interaction in a distributed configuration where a dedicated model-serving component handles inference requests and a separate prompt-construction component integrates results into generative model calls. The terminal can be implemented as a mobile device, a thin client, or a specialized console, as long as it can display visualization information and accept user operations. These variations permit flexible adaptation of the system to different deployment environments while maintaining the technical advantages described above.

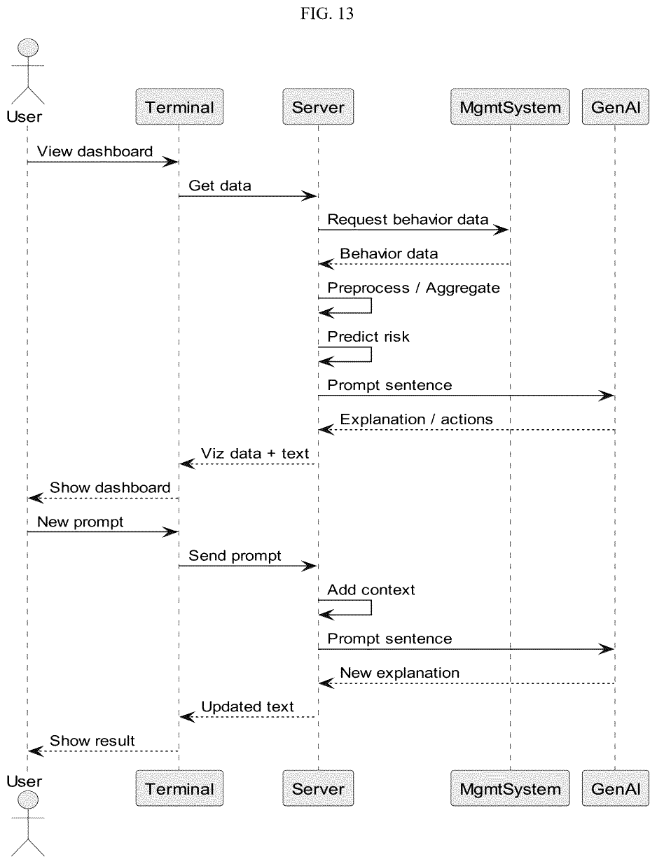

The following describes the processing flow using FIG. 13.

### Step 1:

The server receives, as input, requests for behavioral information from one or more work-related information management devices. The server sends, via a communication network, structured queries that specify a time range, identifiers of work entities, and required fields such as attendance status, delay duration, error counts, and concentration-related flags. The server receives, as output from the management devices, structured response data that includes multiple records of behavioral information. The server parses the response data, converts the records into internal data structures, and writes each record into a relational database, thereby generating stored raw behavioral information associated with work entity identifiers and timestamps.

### Step 2:

The server reads, as input, raw behavioral information from the database for a specified observation period and a specified set of work entities. The server executes preprocessing operations including missing-value correction, outlier removal, and numerical conversion. The server calculates, for each numeric field, statistical measures such as mean and standard deviation and replaces missing entries with representative values; the server identifies values exceeding an outlier threshold and either removes corresponding records or clips the values. The server converts categorical attributes into numeric codes or encoded vectors. The server outputs a cleaned and numerically encoded dataset, stored as normalized tables or in-memory arrays, which is suitable for further aggregation.

### Step 3:

The server receives, as input, the cleaned and numerically encoded dataset produced by the preprocessing and a definition of aggregation periods, such as weekly or monthly time windows. The server groups the records by work entity identifier and by aggregation period and computes aggregated indices such as total delay count, average tardiness duration, total error count, mean work hours, and variance of work hours. The server forms, for each work entity and period, a feature vector that contains these aggregated indices in a fixed order. The server outputs a feature table in which each row corresponds to a work entity-period pair and each column corresponds to a feature value, and stores this table in the database for later use.

### Step 4:

The server reads, as input, the feature table and corresponding post-occurrence event information that indicates whether a work-related problem event occurred after each observation period. The server configures a prediction structure by defining a neural network architecture, including an input layer matching the number of features, multiple hidden layers with nonlinear activation functions, and an output layer producing one or more probabilities of work-related problem events. The server initializes weight parameters, defines a loss function such as cross-entropy, and selects an optimization algorithm such as stochastic gradient descent or an adaptive method. The server then performs an iterative learning operation: for each mini-batch of feature vectors and labels, the server computes forward passes, loss values, gradients via backpropagation, and updated weights. The server outputs a trained prediction structure, including learned parameters and associated metadata, and stores this prediction structure in persistent storage.

### Step 5:

The server receives, as input, new behavioral information for a latest period and a reference to the stored prediction structure and preprocessing configuration. The server applies the same missing-value correction, outlier handling, and numerical conversion used during training to the new data, and groups the resulting records by work entity and period to generate new feature vectors. The server then feeds these feature vectors into the prediction structure, performs forward passes through the neural network, and computes, as output, occurrence probabilities and risk indices for each work-related problem event and each work entity. The server writes the calculated probabilities and risk indices into a prediction results table in the database.

### Step 6:

The server reads, as input, the prediction results table, the feature table, and configuration data specifying which work entities and organizational units to analyze. The server computes derived indicators such as risk trends over multiple periods, rankings of work entities by risk index, and aggregate risk values by organizational unit. The server evaluates constraints on available resources such as hours or capacity and executes a resource allocation algorithm that uses risk indices and constraints as inputs. The server outputs resource allocation plan information that specifies, for each work entity or organizational unit, adjusted schedules, workload distribution, or intervention priorities, and stores this plan in the database.

### Step 7:

The server receives, as input, the inference-use feature values, the risk indices, and optionally the resource allocation plan information for a particular work entity or group. The server constructs a generation input text by embedding numerical values and trends into natural language statements that describe the current risk situation. The server combines this text with an analysis request content that instructs a generative AI model to provide explanations or countermeasures. The server generates, as output, a prompt sentence such as “Based on the past one year of attendance data and current prediction scores, explain why Employee A has a high risk of tardiness next month and propose specific countermeasures.” The server sends this prompt sentence to a generative AI model via an external or internal interface.

### Step 8:

The server provides, as input to the generative AI model, the prompt sentence constructed in the previous step, and optionally additional context such as summarized feature values and risk indices. The generative AI model returns, as output to the server, response information that includes explanatory information describing causes of risk and countermeasure information suggesting specific actions. The server parses the response information, extracts explanatory sections and recommendation sections, and associates them with the corresponding work entity identifiers and time ranges in the database, thereby generating enriched analysis records.

### Step 9:

The server receives, as input, the resource allocation plan information, the risk indices, the explanatory information, and the countermeasure information associated with selected work entities or organizational units. The server formats this data into visualization data structures including time-series arrays for risk indices, lists of high-risk work entities, and tables of proposed actions and resource assignments. The server outputs, to each terminal, structured responses containing these visualization elements, along with layout instructions for charts, tables, and textual summaries.

### Step 10:

The terminal receives, as input, the structured visualization data from the server through the communication network. The terminal executes user interface code that converts the data into on-screen elements such as line graphs, bar charts, and tables on the display. The terminal renders, as output to the user, a dashboard view that includes visual indications of risk levels, trends, and resource allocation plans, as well as textual explanatory information and recommended countermeasures obtained from the generative AI model. The terminal updates the display dynamically when new visualization data is received or when the user changes filters or selections.

### Step 11:

The user receives, as input, the visualized risk indices, resource allocation plans, and generated explanations displayed on the terminal. The user performs countermeasure planning operations such as selecting a particular work entity, modifying proposed schedules, or requesting additional analysis. The user may enter a new prompt sentence through a text input field, for example: “Using the last 12 months of behavior data, list the top 10 employees with the highest predicted risk of work delays next quarter and propose prioritized intervention plans.” The user submits this input to the terminal, which forwards it to the server as updated analysis instructions.

### Step 12:

The server receives, as input, the user-specified prompt sentence and any associated selection context (such as chosen work entities or time ranges). The server retrieves relevant feature values, risk indices, and performance indices for the prediction structure, and reconstructs or augments a generation input text that embeds these numerical details. The server generates a new prompt sentence that combines the user's request with the structured data, then sends this new prompt sentence to the generative AI model. The server receives, as output, updated response information containing revised explanations or countermeasures and stores these results in the database.

### Step 13:

The server receives, as input, ongoing behavioral information streams and stored performance indices of the prediction structure. The server monitors the distribution of feature values and compares them with historical distributions to detect drift, and periodically evaluates the prediction structure using newly labeled data. When performance indices, such as validation accuracy or area under the curve, fall below a threshold, the server reconfigures structural elements and learning conditions, such as the number of layers, hidden units, or learning rate. The server retrains the prediction structure using updated feature values and labels and outputs a new prediction structure with improved parameters, which replaces the previous one in inference operations.

### Step 14:

The terminal receives, as input, updated visualization data computed using the retrained prediction structure and the latest response information from the generative AI model. The terminal re-renders the dashboard, showing revised risk indices and updated explanations that result from the improved model. The terminal outputs, to the user, a refreshed interface that reflects the current state of predictions and recommendations, enabling the user to base subsequent planning actions on technically improved, more accurate, and more recent computational analyses.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented monitoring and decision support systems that track workers, equipment, and operational resources suffer from several technical limitations.

First, such systems typically implement fixed rule engines or pre-defined workflows in software, which require engineers to hard-code detection logic, thresholds, and response patterns. As operational environments, behavior patterns, and failure modes evolve, these static configurations become obsolete, leading to degraded detection accuracy, increased false positives and false negatives, and frequent manual reconfiguration. This degrades the overall performance of the data processing pipeline executed by the information processing apparatus.

Second, existing systems often treat heterogeneous data streams—such as time-series sensor signals, discrete activity logs, communication records, and emotion-related indicators—in isolation. Separate analytic modules are executed for each data type, and their outputs are combined only in a simplistic manner, for example, through fixed weighting or manual review. This fragmented architecture prevents the processor from efficiently leveraging correlations between behavioral changes, emotional states, and equipment conditions. As a result, the underlying computing system cannot reliably predict complex problems such as simultaneous work delays and equipment failures, or early signs of personnel risk, thereby limiting the technical effect that could be achieved by integrated data analysis.

Third, when suggestions or countermeasures are produced, conventional systems typically rely on predetermined templates or static decision trees executed by the processor. These mechanisms are poorly suited to handle novel or rare patterns in the input data, and they do not adapt based on feedback from users. Therefore, the system cannot optimize its internal models, thresholds, or control logic as operating conditions change, which again leads to inefficiencies in the computer's operation, including suboptimal resource allocation computations and redundant or ineffective notifications.

Fourth, prior systems that attempt to use artificial intelligence generally apply black-box predictive models without explicit control over the reasoning process. In particular, they do not use prompt sentences or similar structured instructions to direct a generative AI model to perform specific, context-aware analyses and to output machine-processable, structured plans. As a consequence, the processor receives free-form text that is not tightly integrated with the rest of the processing pipeline, requiring additional manual interpretation and preventing automated updates to thresholds, models, and resource allocation logic. This results in increased processing latency, unnecessarily high computational load, and reduced reliability of the end-to-end decision-making workflow.

Accordingly, there is a need for an improved computer-implemented system and processing method that: (i) systematically collects and preprocesses heterogeneous behavior, state, and environment information as unified analysis target information; (ii) programmatically constructs and uses prompt sentences to control a generative AI model so that the model performs prediction, cause analysis, remedial measure generation, and resource allocation calculation in a structured and machine-integrated fashion; and (iii) uses feedback regarding implemented plans to automatically adjust prompt contents, prediction thresholds, and models. By addressing these issues, the invention aims to improve the functioning of the underlying computer system itself, including the accuracy, adaptability, and efficiency of problem detection, recommendation generation, and resource allocation computations.

The specific processing by the specific processing unit 290 of the data processing device 12 in Application Example 2 is realized by the following means.

The present invention provides a server comprising a processor configured to collect, preprocess, and store, in a storage apparatus, heterogeneous behavior information, state information, and environment information regarding workers and equipment as unified analysis target information; to generate and input, to a generative AI model, prompt sentences that include at least summary information of the analysis target information and analysis objectives, so as to cause the generative AI model to execute prediction processing that outputs probabilities or risk levels of work-related problems, equipment abnormalities, and emotional state changes; to generate and input further prompt sentences including detected problem types, identifiers of target workers or equipment, and related behavior and emotional information, so as to cause the generative AI model to output structured cause analysis information and multiple remedial measure candidates as a countermeasure plan; to generate and input additional prompt sentences including at least prediction results and the countermeasure plan, so as to cause the generative AI model to compute optimal or near-optimal resource allocation information including personnel assignment, task assignment, maintenance scheduling, and equipment operating time allocation; to notify a user terminal of the countermeasure plan and the resource allocation information, receive approval or modification information from the user terminal, update the countermeasure plan and the resource allocation information based on the received information, and store update results as learning information; and to update, based on the learning information, at least one of contents of the prompt sentences, thresholds used in the prediction processing, and models used in the prediction processing. This enables the computer system to more accurately and efficiently detect complex operational problems, to automatically generate and refine structured remedial and allocation plans in a manner tightly integrated with the system's data pipelines, and to adapt its internal models and prompt configurations over time, thereby improving the technical performance, reliability, and resource utilization of the underlying information processing infrastructure.

The term “processor” refers to a hardware computation unit or a combination of hardware computation units and executable instructions that perform arithmetic, logical, control, and input/output operations to execute the functions described in this specification and claims.

The term “storage apparatus” refers to any hardware data storage component, including volatile memory, non-volatile memory, or external storage devices, that is configured to store programs, configuration information, intermediate data, analysis target information, prediction results, countermeasure plans, resource allocation information, and learning information.

The term “information processing apparatus” refers to an electronic computing device, such as a server, client terminal, or embedded controller, that is capable of executing programs, processing digital data, and communicating with other devices over a communication network.

The term “sensing apparatus” refers to any hardware device configured to detect physical or behavioral phenomena and convert them into digital data, including but not limited to sensors, cameras, microphones, and wearable devices.

The term “worker” refers to an individual who performs tasks, operations, or services within an organization and whose behavior information, state information, or emotional information is collected and analyzed by the system.

The term “equipment” refers to a machine, device, or physical system that performs an operation or process, and that generates state information, operation history information, or sensor information used as input to the system.

The term “behavior information” refers to data representing actions, activities, or operational patterns of workers or equipment, including but not limited to task execution logs, operation histories, movement patterns, application usage histories, and interaction histories.

The term “state information” refers to data indicating a condition or status of a worker or equipment at a given time, including but not limited to workload level, operational mode, performance level, fault state, or availability state.

The term “environment information” refers to data representing surrounding or contextual conditions that may affect workers or equipment, including but not limited to time-of-day, location, environmental sensor readings, and organizational context information.

The term “analysis target information” refers to integrated and preprocessed data derived from behavior information, state information, environment information, and other related inputs, which are structured for use in prediction processing, cause analysis, and resource allocation computations.

The term “preprocess” refers to a series of data manipulation operations performed before analysis, including but not limited to cleaning, normalizing, encoding, aggregating, structuring into time-series, and transforming raw data into the analysis target information.

The term “prediction processing” refers to computational operations that estimate probabilities of occurrence or risk levels of future events or conditions, such as work delays, equipment failures, or emotional state changes, based on the analysis target information.

The term “statistical processing” refers to numerical computation methods that analyze data distributions, correlations, and trends, including but not limited to regression analysis, clustering, and time-series analysis, used to support or implement prediction processing.

The term “machine learning processing” refers to a computational method in which a model is trained on data to automatically learn patterns or relationships and then used to perform prediction, classification, or estimation on new data.

The term “generative AI model” refers to an artificial intelligence model that generates new data or content, including text or structured output, based on input data and instructions, and that is capable of performing context-dependent reasoning, explanation, and proposal of actions.

The term “prompt sentence” refers to a textual instruction or structured command provided to the generative AI model, specifying an analysis objective, required output format, and contextual data, thereby controlling the behavior and output of the generative AI model.

The term “summary information” refers to condensed or aggregated representations of the analysis target information, including numerical summaries, statistical features, or key indicators, used as part of the input to the generative AI model.

The term “analysis objective” refers to a description of a task that the generative AI model is requested to perform, such as predicting risks, explaining causes, proposing remedial measures, or calculating resource allocation plans.

The term “problem” refers to an undesirable or abnormal operational condition, including but not limited to work delay, attendance irregularity, operational error, efficiency decrease, equipment abnormality, equipment failure precursor, and change in emotional state.

The term “cause analysis information” refers to data or explanations generated by the generative AI model that identify likely reasons or contributing factors underlying a detected problem.

The term “remedial measure candidate” refers to a proposed action or set of actions intended to mitigate, prevent, or correct a detected or predicted problem, such as adjusting schedules, reassigning tasks, or performing maintenance.

The term “countermeasure plan” refers to a structured and machine-processable representation of one or more remedial measure candidates, including target entities, action contents, priorities, and execution timing.

The term “resource allocation information” refers to data indicating how resources such as personnel, tasks, time slots, and equipment usage should be distributed or scheduled to achieve an operational objective, such as minimizing resource loss or maintaining efficiency.

The term “resource allocation plan” refers to an optimal or near-optimal configuration of resource allocation information generated by the generative AI model, specifying assignments, schedules, and usage levels for relevant resources.

The term “user terminal” refers to an information processing apparatus operated by a human user, configured to receive notifications, display plans or recommendations, and send approval information or modification information back to the server.

The term “approval information” refers to input data indicating that a user has accepted or confirmed at least part of a countermeasure plan or resource allocation plan.

The term “modification information” refers to input data indicating that a user has altered or overridden at least part of a countermeasure plan or resource allocation plan, including changes to actions, priorities, or schedules.

The term “learning information” refers to data derived from update results, user approvals, user modifications, and actual outcomes of executed plans, which are stored for use in refining prompt sentences, thresholds, and models.

The term “threshold of the prediction processing” refers to a numerical or logical criterion used to determine whether a predicted probability or score is sufficient to classify a state as a problem, trigger a notification, or initiate further analysis.

The term “model used in the prediction processing” refers to any computational model, including statistical models and machine learning models, that receives the analysis target information as input and outputs prediction scores, probabilities, or risk levels.

The term “risk level” refers to a quantitative or qualitative indication of the likelihood and/or impact of a potential problem, which may be expressed as a probability, score, or category such as low, medium, or high.

The term “emotion estimation information” refers to data representing inferred emotional states of workers, obtained from text, speech, facial expressions, physiological signals, or other observable indicators, and used as part of the analysis target information.

The term “past case information” refers to historical data records, including previous analysis target information, detected problems, executed plans, and outcomes, which are used as training or reference examples for the generative AI model or other models.

The term “personnel risk” refers to a risk associated with workers, including but not limited to retirement risk, disengagement risk, or performance degradation risk, that may impact organizational operations.

The term “risk evaluation index” refers to a numerical or categorical indicator generated by the generative AI model that quantifies or classifies a personnel risk or other problem-related risk.

The term “communication interface” refers to hardware and software components that enable data exchange between the server and external devices, including user terminals and sensing apparatuses, over one or more communication networks.

In one embodiment, a server cooperates with one or more terminals to implement the claimed system. The server includes at least one hardware processor, a main memory, a non-volatile storage apparatus such as a disk device or solid-state drive, and a communication interface connected to a communication network. The terminal includes a hardware processor, a memory, user-interface components such as a display and input unit, and optionally sensing apparatuses such as cameras, microphones, and environmental sensors.

The server executes a program stored in the storage apparatus. The program is implemented, for example, using an operating system, a database management system, and a runtime environment for a programming language such as a scripting language or a compiled language. The server uses software libraries for numerical computation and data processing, such as a matrix manipulation library and a data frame library, and uses machine learning frameworks such as a neural-network framework or a tensor computation framework. The server further uses a natural language processing library to handle prompt sentences for a generative AI model.

The server acquires behavior information, state information, and environment information from one or more information processing apparatuses and sensing apparatuses associated with workers and equipment. The server receives, for example, equipment sensor data (temperature, vibration, motor current, rotational speed), worker activity logs (application usage, keypress counts, pointer movement, task completion records), environment readings (ambient temperature, noise level, lighting level), and communication content (text messages, emails, transcripts of spoken utterances). The server stores these data streams in a relational database or a time-series database implemented in the storage apparatus.

The server preprocesses the collected information to generate analysis target information. The server uses a data frame library to perform cleaning of missing values, removal of outliers based on statistical thresholds, normalization of numeric attributes, and encoding of categorical attributes into numerical vectors. The server groups raw records into fixed-length time windows and constructs time-series tensors having dimensions corresponding to batch, time, and feature indices. The server also aggregates event-based logs into feature vectors summarizing counts, averages, variances, and recent trends over sliding windows. The server constructs separate feature sets for workers and for equipment but stores them in a unified representation so that downstream models can consume concatenated vectors.

The server executes prediction processing by applying statistical processing and machine learning processing to the analysis target information. In one example, the server uses a recurrent neural network such as a long short-term memory (LSTM) network implemented in the neural-network framework to model time-series equipment sensor data. The server feeds sequences of sensor readings into the LSTM network and obtains predicted next-step values or anomaly scores derived from reconstruction errors. In another example, the server uses a feed-forward neural network or a gradient boosting model to estimate probabilities of work delay or equipment failure based on aggregated features.

The server trains these models using historical data stored as past case information in the storage apparatus. During training, the server splits labeled historical data into training and validation sets, computes a loss function such as mean squared error for regression tasks or cross-entropy for classification tasks, and updates model parameters using an optimization algorithm such as stochastic gradient descent or an adaptive method. The server performs backpropagation to compute gradients of the loss with respect to model weights and applies weight updates for each batch of training data. The server can perform data augmentation, such as adding noise to sensor signals or perturbing time windows, to improve generalization. By optimizing these models, the server improves the accuracy and robustness of prediction processing, thereby reducing false positives and false negatives relative to static rule-based systems.

The server generates prompt sentences to control a generative AI model. The server constructs each prompt sentence by combining an analysis objective with structured or summarized data elements. The server, for example, converts numerical features into textual descriptions such as “average vibration amplitude over the last 10 minutes increased by 30% compared to baseline,” or “worker's daily task completion count decreased by 40% this week.” The server embeds these descriptions into a prompt sentence that instructs the generative AI model to perform a specific type of reasoning and to output results in a structured textual format.

The server uses prompt sentences such as:
“Analyze the following machine sensor data and anomaly scores, identify whether there is an abnormal condition or efficiency drop, explain the most probable cause, and propose up to three concrete maintenance actions with priorities.”
“Using the attached work-log and attendance data for employee ID 123, analyze the risk of schedule delay next month, list the main contributing factors, and propose specific management actions to reduce that risk.”
“Analyze the recent email and chat messages, together with emotion scores and performance indicators for this employee, detect any signs of dissatisfaction or loss of motivation, and suggest targeted support measures to prevent burnout or resignation.”
“Based on the predicted work delays, machine availability, and employee workload statistics below, calculate an optimized resource allocation plan that minimizes resource loss while maintaining overall productivity. Present the result as a list of assignments and schedule adjustments.”

The server inputs these prompt sentences, together with embedded or appended context data, to the generative AI model. The generative AI model is implemented, for example, as a transformer-based neural network configured for conditional text generation. The generative AI model receives tokenized prompt text, maps tokens to embeddings, processes them through multiple attention layers, and outputs probability distributions over tokens of the response. The server controls parameters such as temperature, top-k, or top-p to balance determinism and diversity. The server also constrains the output length to enforce efficient use of compute resources.

The server parses the generated output and converts it into structured internal representations. The server uses pattern matching or a lightweight parser to extract recommended actions, assigned priorities, time frames, and targeted workers or equipment identifiers from the generated text. The server stores these extracted elements as a countermeasure plan in the storage apparatus. By requiring the generative AI model to follow explicit prompt sentences with requested structure, the server reduces ambiguity of the output and eliminates the need for extensive human interpretation, which improves processing speed and consistency.

The server generates resource allocation information using the generative AI model under control of dedicated prompt sentences. The server assembles a summary of current workloads, predicted delays, machine availability windows, and previously planned maintenance tasks. The server encodes this summary into text and constructs a prompt sentence instructing the generative AI model to compute an optimal or near-optimal resource allocation plan. The server requests the model to output assignments in a machine-readable template, for example as lines each containing a worker identifier, a task identifier, a time slot, and a priority label. The server then maps this allocation plan into an internal scheduling data structure used to configure maintenance windows, task queues, and resource reservations.

The terminal receives notifications from the server that contain the countermeasure plan and the resource allocation plan. The terminal displays these plans to a user in a graphical user interface. The terminal shows, for example, a list of predicted problems, associated risk levels, recommended remedial actions, and proposed schedule adjustments for each worker and each equipment unit. The terminal allows the user to inspect details, override specific recommendations, adjust priorities, and approve or reject the proposed plan. The terminal transmits the user's approval information or modification information to the server over a secure protocol.

The user operates the terminal to review, adjust, and approve the plans. The user can, for example, accept maintenance actions but change the suggested execution time, or approve workload redistribution while excluding specific workers. The user can provide feedback regarding the perceived usefulness of recommendations. This interaction generates labeled outcome data that the server uses as learning information.

The server stores the approval information, modification information, and real-world outcomes as learning information. The server correlates which predicted problems actually occurred, which remedial actions were implemented, and what their impacts were on metrics such as failure incidence, downtime, work delay, and resource utilization. The server analyzes this learning information to update prompt contents, prediction thresholds, and model configurations. For example, the server may adjust a decision threshold if repeated feedback indicates that problems of a certain predicted probability rarely materialize, or may alter a prompt sentence to request more concise and prioritized outputs when users frequently shorten or re-prioritize recommendations.

The server thereby improves the internal operation of the computing system. The server reduces redundant alerts and unnecessary computations by calibrating thresholds, and improves the relevance and structure of generative AI outputs by refining prompt sentences. Because the server integrates feedback into both discriminative prediction models and the generative AI model's instruction layer, the system reduces processing latency and user cognitive load. This feedback-driven adaptation goes beyond simple automation of human decision-making and instead optimizes data structures, control flows, and resource usage within the computer.

The server, in some embodiments, executes separate specialized neural network components for emotion estimation and for operational prediction. For emotion estimation, the server may use a transformer-based classifier trained on textual data to output discrete emotion labels and continuous sentiment scores. The server may also use a convolutional or recurrent network for audio features derived from speech, and a convolutional network for facial expression features. The server combines these modalities through feature concatenation or attention-based fusion to generate robust emotion estimation information. This multi-modal architecture improves classification accuracy and robustness compared to single-channel systems, which in turn reduces noise in downstream risk predictions.

The server controls the generative AI model in a non-conventional way by systematically embedding structured feature summaries and analysis objectives into prompt sentences. Rather than passing raw free-form narratives, the server synthesizes prompt sentences that enumerate key statistics, highlight trend changes, and specify required output structures. This design causes the generative AI model to behave more like a programmable reasoning component integrated into the data pipeline than a stand-alone conversational agent. As a result, the server can systematically parse outputs, feed them into other modules, and close the loop with prediction and scheduling logic. This architecture improves computational efficiency and stabilizes response formats, which are technical improvements over conventional ad-hoc use of AI models.

The server, in further embodiments, implements caching and incremental computation mechanisms. The server caches intermediate feature vectors and model outputs so that when new data arrive that do not change certain segments of the time window, the server reuses previous computations instead of recomputing everything from scratch. The server also maintains index structures in the storage apparatus to quickly retrieve relevant segments of historical data when building analysis target information for a given worker or equipment. These mechanisms reduce processing time and lower CPU and memory load, thereby improving the scalability of the system.

The server, in alternative embodiments, deploys lighter-weight models on the terminal for preliminary filtering. For example, the terminal may run a small anomaly detector that flags only candidate segments of sensor data for detailed analysis by the server. The terminal may also perform on-device compression or downsampling before transmitting data. By offloading these tasks to the terminal, the server reduces communication bandwidth consumption and central processing workload, which is a technical improvement in networked computer systems.

The server, in other embodiments, uses alternative neural network architectures such as temporal convolutional networks or attention-based time-series models in place of or in addition to LSTM networks. The server may also employ different loss functions, such as focal loss for imbalanced classification or custom cost functions that penalize false negatives more heavily in safety-critical contexts. The server may further use ensemble techniques that combine outputs from multiple models to increase prediction robustness. These variations change the internal computation of the server and enable further trade-offs between accuracy and computational cost.

The server, in further variations, refines the generative AI model by fine-tuning it on domain-specific prompt-response pairs stored in the storage apparatus. The server uses logged prompts and human-approved responses as training data, defines a supervised learning objective over the generative model's next-token prediction distribution, and updates model weights using gradient-based optimization. By doing so, the server aligns the generative AI model with the specific structural and semantic requirements of the system, such as consistently outputting clearly labeled action lists and risk descriptions. This fine-tuning process directly improves the quality and predictability of the generative AI model's outputs and enhances the overall technical performance of the decision support workflow.

Through these hardware and software configurations, and through the explicit integration of prediction models, structured prompt sentences, generative AI outputs, and feedback-driven updates, the server and the terminal implement the claimed system in a manner that improves computer technology itself. The system reduces computational overhead by reusing intermediate results, enhances data management by enforcing unified analysis target information and structured plans, increases prediction and recommendation accuracy through advanced neural architectures and continuous learning, and decreases communication load through selective preprocessing on terminals. These technical effects arise from the specific data structures, model architectures, prompt control mechanisms, and feedback-driven adaptation described above, and are not merely an automation of human mental processes.

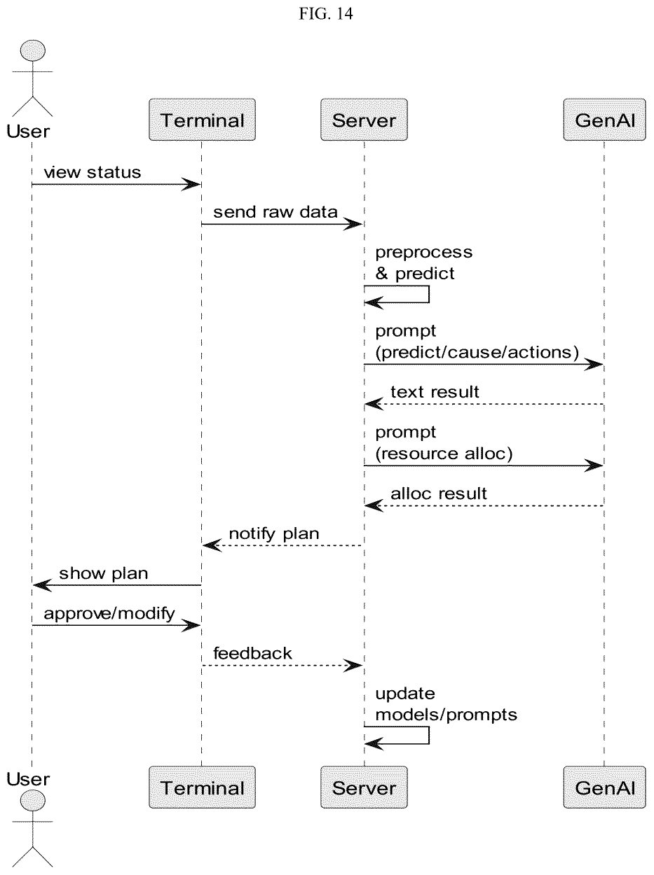

The following describes the processing flow using FIG. 14.

### Step 1:

The terminal acquires raw observation data related to workers and equipment.
The terminal uses local sensing apparatuses such as cameras, microphones, motion sensors, and input-activity loggers to capture behavior information, state information, and environment information. As input, the terminal receives physical signals (for example, video frames, audio waveforms, accelerometer values), user interaction events (for example, keypress events, pointer movements, active window changes), and optionally equipment interface data (for example, basic status flags from a connected controller). The terminal converts these raw signals into digitized records with timestamps and identifiers, performs optional lightweight preprocessing such as downsampling, compression, and simple feature extraction (for example, frame rate reduction, audio volume level calculation), and produces as output data packets containing structured raw observation data ready to be transmitted to the server.

### Step 2:

The server receives and stores heterogeneous raw data from the terminals and sensing apparatuses.
The server uses a communication interface to accept incoming data packets over a network protocol. As input, the server receives the structured raw observation data including worker identifiers, equipment identifiers, timestamps, and modality indicators (for example, “sensor,” “application log,” “text message”). The server validates packet integrity, decrypts payloads if necessary, and writes the records into a storage apparatus using a relational or time-series database schema. The server performs data organization operations such as partitioning by time and identifier, indexing by worker and equipment, and tagging each record with a source type. As output, the server maintains persistent raw data tables and indexes that allow efficient retrieval for subsequent preprocessing.

### Step 3:

The server preprocesses raw data to generate unified analysis target information.
The server retrieves subsets of raw records from the storage apparatus based on time ranges and target identifiers. As input, the server uses raw sensor streams, application usage logs, task completion logs, attendance records, communication texts, and any previously computed low-level features. The server applies data frame and numerical libraries to perform data cleaning (for example, removal of records with invalid values, interpolation of missing timestamps), normalization (for example, scaling vibration amplitudes, standardizing durations), and encoding (for example, one-hot encoding of categorical fields such as department or equipment type). The server aggregates events into fixed-length time windows and computes statistical features such as counts, means, standard deviations, trend slopes, and moving averages. The server stacks time-ordered feature vectors into multi-dimensional arrays representing time-series tensors for sequence models and tabular matrices for non-sequence models. As output, the server produces structured analysis target information where each worker or equipment is associated with feature sequences and aggregated feature vectors.

### Step 4:

The server executes prediction models to estimate risk levels for problems.
The server loads trained prediction models from the storage apparatus into memory. As input, the server uses the analysis target information associated with each worker and equipment, including time-series tensors and aggregated feature vectors. The server feeds time-series tensors into sequence models such as recurrent neural networks or temporal convolutional networks and feeds aggregated vectors into classification or regression models. The server performs forward propagation through each model layer, computing intermediate activations and final outputs such as predicted probabilities of work delay, attendance irregularity, equipment abnormality, failure precursors, and emotional state transitions. The server then applies thresholding and calibration operations, mapping raw probabilities to discrete risk levels (for example, low, medium, high) based on predefined or learned thresholds. As output, the server generates prediction records that associate each entity and time window with predicted risk values and risk categories.

### Step 5:

The server detects problem instances and selects relevant context for generative analysis.
The server scans prediction records to identify entries where at least one risk level exceeds a trigger threshold. As input, the server uses the probability and risk-category fields generated in Step 4, along with references to the underlying analysis target information. The server performs filtering operations to select only high-risk cases, groups them by worker or equipment, and retrieves associated feature summaries and recent history segments from the storage apparatus. The server generates context descriptors such as “recent increase in delay frequency,” “sharp rise in vibration amplitude,” or “sustained negative sentiment in communication logs” by transforming numerical features into textual or symbolic annotations. As output, the server produces a collection of problem instances, each containing a detected problem type, target identifier, and a structured set of contextual feature summaries.

### Step 6:

The server constructs prompt sentences to control the generative AI model.
The server uses the problem instances as the basis for textual instruction generation. As input, the server uses the problem type (for example, work delay, equipment failure risk), the target identifier (worker or equipment ID), and the contextual feature summaries assembled in Step 5. The server applies string-construction logic to embed these elements into task-specific templates, thereby forming prompt sentences. The server may create, for example, a prompt sentence such as:
“Analyze the following machine sensor data and anomaly scores, identify whether there is an abnormal condition or efficiency drop, explain the most probable cause, and propose up to three concrete maintenance actions with priorities.”
For worker-related problems, the server may create a prompt sentence such as:
“Using the attached work-log and attendance data for employee ID 123, analyze the risk of schedule delay next month, list the main contributing factors, and propose specific management actions to reduce that risk.”
The server appends textual summaries of key numeric features and, where applicable, emotional indicators to these instructions. As output, the server produces complete prompt texts that encode both the analysis objectives and the relevant contextual data in natural language form.

### Step 7:

The server invokes the generative AI model and obtains structured countermeasure proposals.
The server sends the constructed prompt sentences to a generative AI model via an internal interface or an external inference service. As input, the server provides tokenized prompt texts that include instructions and embedded summaries of the analysis target information. The server sets generation parameters such as maximum token length and response constraints and then initiates inference. The generative AI model processes the token sequences through its transformer layers and outputs response tokens that, when decoded, form natural-language explanations and recommendations. The server receives these generated texts and performs parsing operations, such as splitting the response into issue descriptions, cause analyses, and action items, and detecting priority labels or time indications. As output, the server creates structured countermeasure plans that represent each recommended remedial measure with explicit fields including action type, target entity, priority, and suggested time frame.

### Step 8:

The server generates resource allocation plans using the generative AI model under prompt control.
The server aggregates current workload data, predicted risk profiles, and available resource information. As input, the server uses counters for open tasks, capacities of workers and equipment, calendar availability, and the countermeasure plans generated in Step 7. The server computes intermediate statistics, such as total predicted demand per skill category and available hours per resource, and generates a textual summary of these constraints and objectives. The server constructs a prompt sentence that requests an optimized or near-optimized resource allocation, for example:
“Based on the predicted work delays, machine availability, and employee workload statistics below, calculate an optimized resource allocation plan that minimizes resource loss while maintaining overall productivity. Present the result as a list of assignments and schedule adjustments.”
The server sends this prompt and the summarized data to the generative AI model, receives a textual allocation proposal, and parses the proposal into internal schedule entries linking workers, tasks, time slots, and equipment units. As output, the server produces a resource allocation plan that can be applied in scheduling or maintenance systems.

### Step 9:

The server notifies the terminal of detected problems, countermeasure plans, and allocation plans.
The server packages the risk information, explanations, remedial measures, and allocation details into notification messages. As input, the server uses the prediction records from Step 4, the structured countermeasure plans from Step 7, and the resource allocation plan from Step 8. The server formats these data into compact structures suitable for network transmission and user presentation, and assigns identifiers and timestamps to each notification. The server then sends the notifications to the relevant terminals via the communication interface, using protocols that support secure and reliable delivery. As output, the server produces message streams that the terminals can render in user interfaces.

### Step 10:

The terminal presents recommendations to the user and collects user responses.
The terminal receives notification messages from the server. As input, the terminal uses the message contents including descriptions of predicted problems, generated explanations, recommended actions, and proposed schedules. The terminal renders this information in a graphical layout, which may include lists, tables, and charts, and allows the user to interact with the recommendations by selecting, modifying, or rejecting individual items. The terminal captures the user's operations, such as button clicks or edited fields, and converts them into structured approval information or modification information. As output, the terminal produces user-response data that describe which elements of the countermeasure plans and resource allocation plans are approved or changed.

### Step 11:

The server updates plans and stores feedback as learning information.
The server receives user-response data from the terminal. As input, the server uses the approval information and modification information linked to specific recommendations and schedules. The server applies update operations to merge user overrides into the stored countermeasure plans and resource allocation plans, adjusting actions, priorities, and time slots as specified. The server also records the correspondence between original AI-generated proposals and final user-approved configurations. The server then stores these update records, along with later-observed outcomes such as actual delays or failures, as learning information. As output, the server maintains an enriched dataset that links model outputs, human decisions, and real-world results.

### Step 12:

The server refines thresholds, models, and prompt sentences using learning information.
The server periodically analyzes the stored learning information to improve the performance of the overall system. As input, the server uses records of prediction accuracy, effectiveness of remedial actions, user revision patterns, and outcome metrics such as reduced downtime or delay frequency. The server computes evaluation statistics, such as precision and recall for problem detection, average impact of implemented actions, and typical adjustments made by users. Based on these statistics, the server updates prediction thresholds to balance false alarms and missed detections, adjusts model hyperparameters or retrains models using new labeled examples, and revises prompt sentences to request more specific, concise, or structured outputs from the generative AI model. The server writes updated model parameters and revised prompt templates back to the storage apparatus. As output, the server produces an improved configuration that, when used in subsequent iterations of Steps 3 through 11, yields higher accuracy, reduced computational overhead, and more user-aligned recommendations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

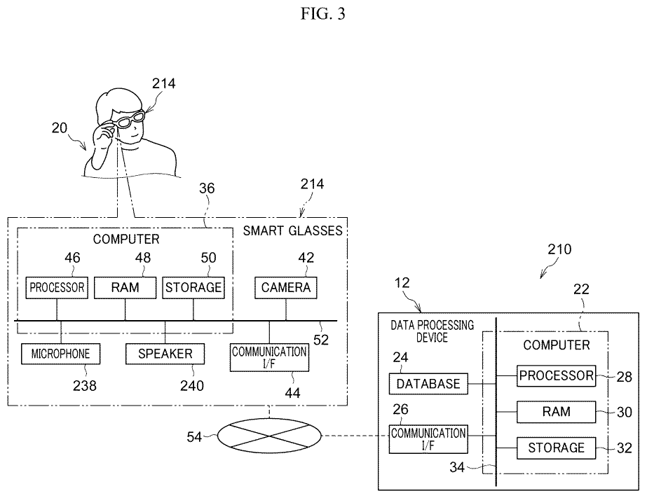

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

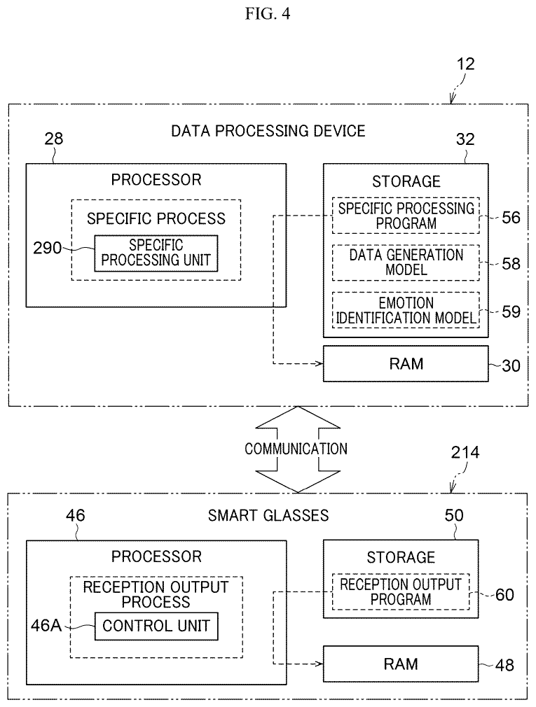

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

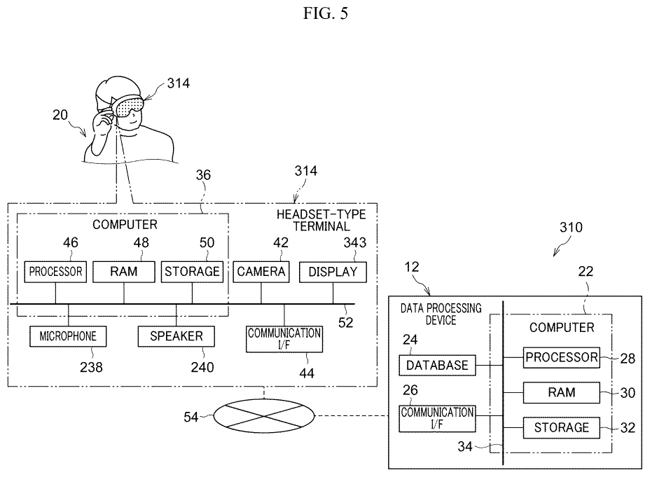

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

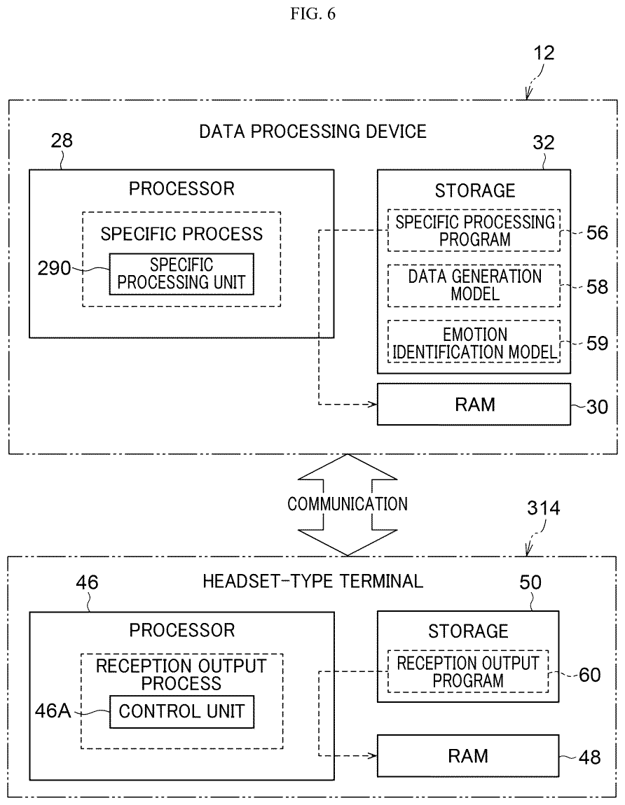

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

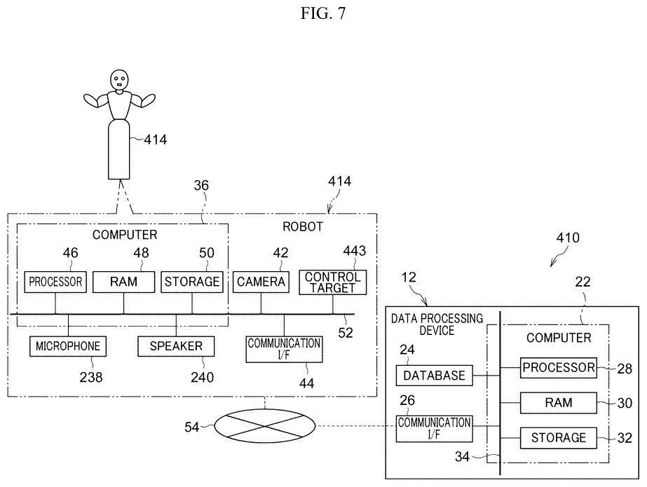

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

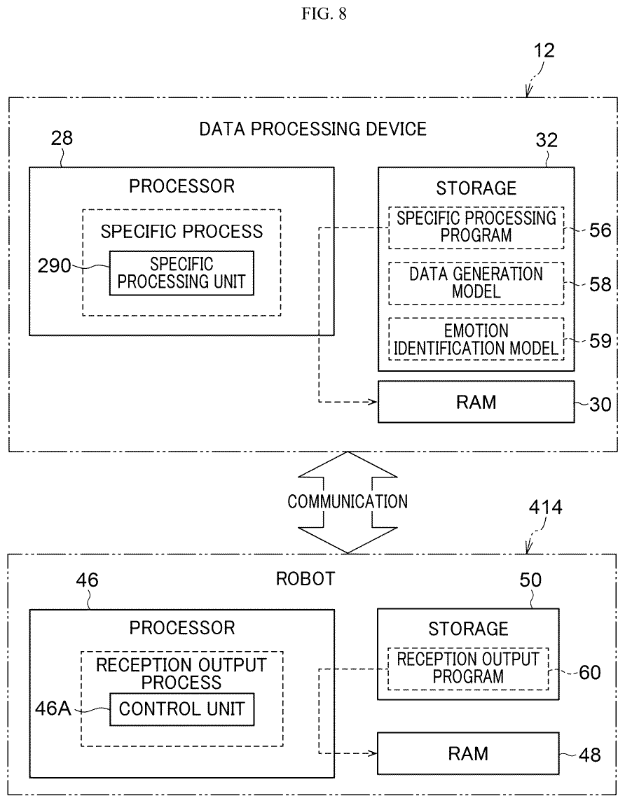

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

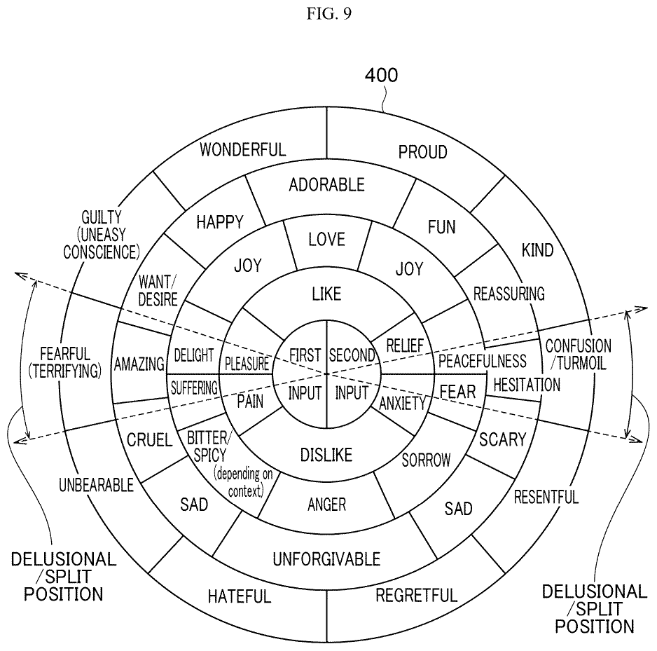

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

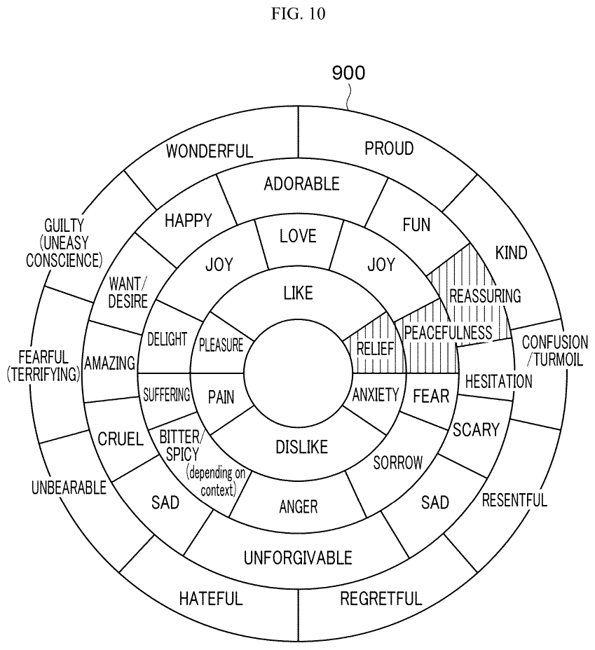

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
collect, via an agent operating on an information processing device, usage-state data including at least a use history of the information processing device, start and end times of operation, types of processing executed on the information processing device and use times thereof, and access history to an information communication network, for each of a plurality of subjects over a predetermined period, and aggregate the usage-state data via a communication network,
format the aggregated usage-state data by performing preprocessing including completion of missing values, removal of abnormal values, and normalization of time information, and
calculate, for each subject and for each predetermined unit period, at least one behavioral feature quantity including at least a start time, an end time, an operation time of the information processing device in the unit period, a use time per processing category on the information processing device, and a use ratio in a predetermined time band, to construct a behavioral feature matrix,
apply, to the behavioral feature matrix, a scaling process on numerical feature quantities and then a machine learning process including a clustering process, classify the subjects into a plurality of behavioral pattern groups, and, for each behavioral pattern group, calculate statistics indicating tendencies of the start times, the end times, the operation times, and the use in a specific time band to generate behavioral pattern information representing characteristics of the behavioral pattern group,
convert analysis results including the behavioral pattern information and belonging-behavioral-pattern-group information for each subject into report information for visual display, and, in response to a viewing request from a management terminal, provide the report information,
generate, in order to detect at an early stage at least one of a business delay, an irregularity in attendance, a minor operational error, a lack of concentration, and an inefficiency in resource allocation, a prompt sentence including analysis-target information based on the behavioral pattern information and the usage-state data, and generate prompt control information that instructs input of the prompt sentence to a generative artificial intelligence model and execution of an analysis process by the generative artificial intelligence model, and
acquire, on the basis of analysis results output from the generative artificial intelligence model, response-measure information including at least one of a remedial measure, an improvement measure, and a resource allocation plan, and associate the response-measure information with the report information for presentation and/or generate control information for automatically executing at least a part of the response-measure information.

### Supplementary 2

The system according to supplementary 1,
wherein the processor is configured to
generate the prompt control information such that the prompt control information includes a prompt sentence for inputting, to the generative artificial intelligence model, history information including past usage-state data and past behavioral pattern information, and for instructing the generative artificial intelligence model to apply a prediction algorithm based on the history information and to predict at least one of a future behavioral pattern, a probability of problem occurrence, and a future resource demand.

### Supplementary 3

The system according to supplementary 1,
wherein the processor is configured to
generate the prompt control information such that the prompt control information includes a prompt sentence for inputting, to the generative artificial intelligence model, evaluation-target information including behavioral feature quantities extracted from the usage-state data and emotion-related data representing an emotional state, and for instructing the generative artificial intelligence model to perform risk evaluation of at least one of a resignation risk and another separation risk based on the evaluation-target information and to extract measure proposals for reducing the risk.

### Application Example 1

### Supplementary 1

A system comprising a processor,
wherein the processor is configured to
acquire human behavior information from information processing terminals connected to an information processing apparatus, and acquire operation information of mechanical equipment from detection devices provided to the mechanical equipment connected to the information processing apparatus,
preprocess the acquired behavior information and operation information in the information processing apparatus by using a general-purpose information processing program, convert the behavior information and the operation information into structured information by performing time information normalization, identifier completion, classification conversion, and aggregation processing, and store the structured information in an information storage apparatus,
generate integrated management information by associating the structured information with attribute information relating to a human, attribute information relating to the mechanical equipment, and maintenance history information, and calculate indicators of an operation state of the human and indicators of an operation state of the mechanical equipment based on the integrated management information,
extract, from the integrated management information, targets for which an indicator relating to fatigue of the human and an indicator relating to maintenance of the mechanical equipment satisfy a predetermined condition, generate a description including past integrated management information and past result information for each extracted target, and generate a prompt sentence including the description to create input information for a generative artificial intelligence model,
input the prompt sentence to the generative artificial intelligence model, cause the generative artificial intelligence model to execute generation of future risk evaluation and countermeasure proposals based on the integrated management information and the past result information, and
acquire prediction information and recommendation information as an output result,
generate planning information for optimizing at least one of a work plan of the human and a maintenance plan of the mechanical equipment based on the prediction information, the recommendation information, and the integrated management information, convert the planning information into visualization information, and output the visualization information to a presentation apparatus, and
update at least a part of the planning information based on operation information of a user input via the presentation apparatus, and record an update result as the integrated management information in the information storage apparatus.

### Supplementary 2

The system according to supplementary 1,
wherein the processor is configured to
extract behavior information and operation information for a predetermined period from the integrated management information, quantify temporal variation trends, differences from reference values, and patterns at times of occurrence of past abnormal events, include the quantified information in the prompt sentence, and thereby generate the prompt sentence that instructs the generative artificial intelligence model to perform risk evaluation and prediction of future states while explicitly indicating application conditions of a prediction algorithm to the generative artificial intelligence model.

### Supplementary 3

The system according to supplementary 1,
wherein the processor is configured to
generate the integrated management information by integrating the behavior information and emotion information relating to the human with the operation information and the maintenance history information relating to the mechanical equipment, input a prompt sentence including the integrated management information to the generative artificial intelligence model, and thereby acquire, as the recommendation information, proposals that simultaneously evaluate a separation risk of the human and a failure risk of the mechanical equipment and propose at least one of work distribution, load adjustment, and maintenance timing to reduce the risks.

### Example 2

### Supplementary 1

A system comprising a processor, a storage device, and a display control device,
wherein the processor is configured to
acquire behavioral information of work entities from a work-related information management device via a communication network and store the behavioral information in the storage device,
execute preprocessing on the behavioral information, the preprocessing including missing-value correction, outlier removal, and numerical conversion, and calculate aggregated indices for each work entity and for each predetermined period to generate a group of feature values,
execute a learning process using the group of feature values and post-occurrence event information corresponding to the group of feature values, thereby generating and storing a prediction structure that represents a relationship between behavioral patterns and work-related problem events,
apply the preprocessing to latest behavioral information to generate an inference-use group of feature values, input the inference-use group of feature values to the prediction structure, and
calculate occurrence probabilities and risk indices of the work-related problem events,
construct, based on the inference-use group of feature values and the risk indices, a generation input text including an analysis request content, generate a prompt sentence for transmitting the generation input text to a generative information processing model, and acquire response information including explanatory information and countermeasure information from the generative information processing model,
aggregate the risk indices and the response information and calculate resource allocation plan information for each work entity and for each organizational unit, and
cause the display control device to display, on a terminal device, visualization information including the resource allocation plan information, the risk indices, and the response information, and to accept countermeasure planning operations by a user.

### Supplementary 2

The system according to supplementary 1,
wherein the processor is configured to
calculate performance indices for the prediction structure based on past behavioral information and past work-related problem event information, update structural elements and learning conditions of the learning process according to the performance indices, and generate a prompt sentence that instructs the generative information processing model to perform an analysis request content including prediction of future work-related problem events based on an updated prediction structure.

### Supplementary 3

The system according to supplementary 1,
wherein the processor is configured to
include behavioral information of work entities and emotion-related information of the work entities in the group of feature values, execute the learning process and an inference process using the group of feature values, calculate a group of risk evaluation indices including a separation possibility index, and generate a prompt sentence that instructs the generative information processing model to present a basis of calculation of the separation possibility index and preventive measure proposals.

### Application Example 2

### Supplementary 1

A system comprising a processor,
wherein the processor is configured to
collect, over a predetermined period, behavior information, state information, and environment information regarding workers and equipment from one or more information processing apparatuses and sensing apparatuses, preprocess the collected information including at least cleaning, normalizing, and time-series structuring of the collected information, and store the preprocessed information as analysis target information in a storage apparatus,
perform prediction processing, based on the analysis target information, by applying statistical processing or machine learning processing to calculate a probability of occurrence or a risk level of one or more problems including work delay, attendance irregularity, operational error, efficiency decrease, equipment abnormality, equipment failure precursor, and change in emotional state, and generate and input, to a generative AI model, a prompt sentence including summary information of the analysis target information and an analysis objective so as to cause the generative AI model to perform the prediction processing,
upon detection of at least one problem in the prediction processing, generate and input, to the generative AI model, a prompt sentence including at least a type of the detected problem, an identifier of a target worker or equipment, and related behavior information and emotional information, so as to cause the generative AI model to generate cause analysis information and a plurality of remedial measure candidates, and output contents of the remedial measure candidates as a structured countermeasure plan,
generate and input, to the generative AI model, a prompt sentence including at least a prediction result and the countermeasure plan so as to cause the generative AI model to generate resource allocation information including assignment of personnel, assignment of tasks, scheduling of maintenance operations, and allocation of equipment operating time that are necessary to suppress resource loss and maintain work efficiency and operating rate, and obtain from the generative AI model an optimal or near-optimal resource allocation plan,
notify, via a communication interface, a user terminal of the resource allocation plan and the countermeasure plan, receive, from the user terminal, approval information or modification information regarding the resource allocation plan and the countermeasure plan, update the resource allocation plan and the countermeasure plan on the basis of the approval information or the modification information, and store update results as learning information in the storage apparatus, and
update, on the basis of the learning information, at least one of contents of the prompt sentence, a threshold of the prediction processing, and a model used in the prediction processing, so as to improve accuracy of subsequent problem detection, cause analysis, remedial measure proposal, and resource allocation calculation.

### Supplementary 2

The system according to supplementary 1,
wherein the processor is configured to
integrate, as the analysis target information, a plurality of types of information including at least work progress information, attendance information, operation history information, communication history information, and emotion estimation information regarding the workers, and operation history information, state monitoring information, and sensor information regarding the equipment, input past case information generated from the integrated information into the generative AI model, and use a prompt sentence instructing application of a prediction algorithm to the past case information so as to cause the generative AI model to simultaneously evaluate future occurrence of work-related problems and equipment failure risks.

### Supplementary 3

The system according to supplementary 1,
wherein the processor is configured to
extract feature quantities including at least an amount of change in behavior, an amount of change in emotional state, a frequency of work delay, and a communication tendency from the behavior information and the emotion estimation information regarding the workers, generate a prompt sentence including the feature quantities, input the prompt sentence into the generative AI model, and cause the generative AI model to generate a risk evaluation index indicating a personnel risk including retirement risk and remedial measure candidates for reducing the personnel risk.

What is claimed is:

1. A system comprising:
circuitry configured to:
collect, via an agent operating on an information processing device and via a communication interface coupled to a packet-switched network, usage-state data including at least a use history of an information processing device, start and end times of operation, types of processing executed, and access history to an information communication network for each of a plurality of subjects over a predetermined period, and store the usage-state data in a storage device;
generate a prompt sentence incorporating the usage-state data and an instruction for a generative AI model to analyze the usage-state data to detect at an early stage problems including operational delays, irregular patterns, and concentration anomalies, input the prompt sentence to the generative AI model, and obtain a problem detection result; and
generate a second prompt sentence incorporating the problem detection result and an instruction for the generative AI model to propose and implement appropriate remedial measures, input the second prompt sentence to the generative AI model, and transmit the remedial measures to a terminal device via the communication interface.

2. The system according to claim 1, wherein the circuitry is configured to collect usage-state data from a plurality of information processing devices via the communication interface, and store the usage-state data in the storage device indexed by subject identifier and time period.

3. The system according to claim 2, wherein the circuitry is configured to generate the prompt sentence incorporating the usage-state data and an instruction for the generative AI model to apply a prediction algorithm to the usage-state data to analyze behavioral patterns of each subject and perform prediction based on past patterns.

4. The system according to claim 3, wherein the circuitry is configured to receive the problem detection result from the generative AI model, parse the result to extract problem identifiers, severity levels, and affected subject identifiers, and store the parsed result in the storage device.

5. The system according to claim 4, wherein the circuitry is configured to generate the second prompt sentence incorporating the extracted problem identifiers, severity levels, and affected subject identifiers, and input the second prompt sentence to the generative AI model to obtain proposed remedial measures for each identified problem.

6. The system according to claim 5, wherein the circuitry is configured to transmit the proposed remedial measures to a terminal device associated with a supervisory user via the communication interface, and receive confirmation or modification of the remedial measures from the terminal device.

7. The system according to claim 1, wherein the circuitry is configured to generate a third prompt sentence incorporating the usage-state data and a resource utilization model, input the third prompt sentence to the generative AI model to calculate an optimal allocation of resources based on the prediction results, and transmit the optimal allocation to a management terminal device via the communication interface.

8. The system according to claim 7, wherein the circuitry is configured to detect resource underutilization or overallocation based on the calculated optimal allocation, and generate an updated resource allocation plan for transmission to the management terminal device.

9. The system according to claim 1, wherein the circuitry is configured to generate a fourth prompt sentence incorporating usage-state data and emotion data of each subject, input the fourth prompt sentence to the generative AI model to perform risk evaluation, and detect early indicators of disengagement risk based on the risk evaluation.

10. The system according to claim 9, wherein the circuitry is configured to generate a risk mitigation plan based on the detected disengagement risk indicators, and transmit the risk mitigation plan to a terminal device associated with a supervisory user via the communication interface.

11. The system according to claim 1, wherein the circuitry is configured to apply an emotion analysis engine to data received from terminal devices of the subjects via the communication interface, recognize emotional states of the subjects, and incorporate the recognized emotional states into the prompt sentences for the generative AI model.

12. The system according to claim 11, wherein the circuitry is configured to adjust the remedial measures based on the recognized emotional states of the subjects, and include emotional context information in the remedial measures transmitted to the supervisory terminal device.

13. The system according to claim 1, wherein the circuitry is configured to receive feedback from the terminal device on the effectiveness of the transmitted remedial measures via the communication interface, incorporate the feedback into the storage device, and update prompt sentence templates for subsequent problem detection and remediation.

14. The system according to claim 13, wherein the circuitry is configured to store a record of problem detection results, remedial measures, and associated feedback in the storage device, and use the stored records to improve the accuracy of the generative AI model's problem detection over time.

15. The system according to claim 1, wherein the circuitry is configured to monitor the usage-state data in real time, detect deviations from established behavioral patterns stored in the storage device, and trigger generation of a new prompt sentence for the generative AI model when a deviation exceeds a significance threshold.

16. The system according to claim 15, wherein the circuitry is configured to generate an alert notification incorporating the deviation details and the subject identifier, and transmit the alert notification to a designated terminal device via the communication interface.

17. The system according to claim 1, wherein the circuitry is configured to generate a periodic summary report by incorporating accumulated usage-state data and problem detection results into a prompt sentence for the generative AI model, and transmit the summary report to a management terminal device via the communication interface.

18. A system comprising:
circuitry configured to:
collect, via an agent and a communication interface coupled to a packet-switched network, usage-state data for a plurality of subjects over a predetermined period, and store the usage-state data in a storage device;
generate a prompt sentence incorporating the usage-state data and an instruction for a generative AI model to detect operational problems and analyze behavioral patterns, input the prompt sentence to the generative AI model, and obtain a problem detection result;
generate a second prompt sentence incorporating the problem detection result and an instruction to propose remedial measures, input the second prompt sentence to the generative AI model, and obtain proposed remedial measures; and
transmit the remedial measures to a terminal device via the communication interface, and update the storage device based on feedback received from the terminal device.

19. The system according to claim 18, wherein the circuitry is configured to generate a third prompt sentence incorporating usage-state data and emotion data of the subjects, input the third prompt sentence to the generative AI model to perform risk evaluation, and transmit a risk mitigation plan based on the risk evaluation to a supervisory terminal device.

20. A method comprising:
collecting, via an agent and a communication interface coupled to a packet-switched network, usage-state data including at least use history, operation times, and network access history for each of a plurality of subjects over a predetermined period, and storing the usage-state data in a storage device;
generating a prompt sentence incorporating the usage-state data and an instruction for a generative AI model to detect operational problems and analyze behavioral patterns, and inputting the prompt sentence to the generative AI model to obtain a problem detection result; and
generating a second prompt sentence incorporating the problem detection result and an instruction to propose remedial measures, inputting the second prompt sentence to the generative AI model, and transmitting the remedial measures to a terminal device via the communication interface.
